(19) United States
(12) Patent Application Publication
(10) Pub. No.: US 2023/0243791 A1
(43) Pub. Date: Aug. 3, 2023

(54) Chromatography Operational Status Analysis

(71) Applicant: Dionex Softron GmbH, Germering (DE)

(72) Inventors: Stefan Andreas Seitz, Germering (DE); Christoph Strobl, Munich (DE); Bastian Engelmann, Munich (DE)

(21) Appl. No.: 18/151,162

(22) Filed: Jan. 6, 2023

Related U.S. Application Data
(60) Provisional application No. 63/305,980, filed on Feb. 2, 2022.

(51) Int. Cl. G01N 30/88; G01N 30/32; G01N 30/16

(52) U.S. Cl. CPC G01N 30/88; G01N 30/32; G01N 30/16; G01N 2030/027

(57) ABSTRACT

Disclosed herein are chromatography support systems, as well as related methods, computing devices, and computer-readable media. For example, in some embodiments, the systems and methods disclosed herein may enable the automatic identification of error or fault conditions in a chromatography system.

### CROSS-REFERENCE TO RELATED APPLICATIONS

This application claims priority to and is a non-provisional of U.S. Provisional Patent Application No. 63/305,980 filed Feb. 2, 2022, which is hereby incorporated by reference herein for any and all purposes.

### BACKGROUND

Chromatography systems, such as high-performance liquid chromatography (HPLC) systems, may include a complex arrangement of movable components, sensors, input and output ports, energy sources, and consumable components. Failures or changes in any part of this arrangement may result in a “downed” instrument, one that is not able to perform its intended function.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, not by way of limitation, in the figures of the accompanying drawings.

FIG. 1 is a plot depicting an example time course of the mixing of two liquids through a pump in a chromatography system, in accordance with various embodiments.

FIG. 2 is a plot depicting an example pressure curve associated with the mixing illustrated in FIG. 1, in accordance with various embodiments.

FIG. 3 is a plot depicting a section of the pressure curve of FIG. 2, in accordance with various embodiments.

FIG. 4 is a plot depicting an example cyclic pressure signal, in accordance with various embodiments.

FIG. 5 is a plot depicting the generation of a reference curve from an example measured pressure curve, in accordance with various embodiments.

FIG. 6 is a plot depicting the deviation of an example pressure signal from a reference signal, in accordance with various embodiments.

FIG. 7 illustrates an example injection setting in which various ones of the embodiments disclosed herein may operate.

FIG. 8 illustrates a pressure/compression/pulsation signal of a normal injection in a chromatography system, in accordance with various embodiments.

FIGS. 9-10 illustrate calculation of a pulsation signal from a pressure signal, in accordance with various embodiments.

FIG. 11 illustrates an example of a possible stroke-wise classification, in accordance with various embodiments.

FIG. 12 illustrates a relabeling process, in accordance with various embodiments.

FIG. 13 illustrates a flow diagram for generating a final injection classification, in accordance with various embodiments.

FIG. 14 is a block diagram of an example chromatography support module for performing support operations, in accordance with various embodiments.

FIG. 15 is a flow diagram of an example method of performing support operations, in accordance with various embodiments.

FIG. 16 is an example of a graphical user interface that may be used in the performance of some or all of the support methods disclosed herein, in accordance with various embodiments.

FIG. 17 is a block diagram of an example computing device that may perform some or all of the chromatography support methods disclosed herein, in accordance with various embodiments.

FIG. 18 is a block diagram of an example chromatography support system in which some or all of the chromatography support methods disclosed herein may be performed, in accordance with various embodiments.

FIG. 19 is a flow diagram of an example method of performing support operations, in accordance with various embodiments.

FIG. 20 is a flow diagram of an example method of performing support operations, in accordance with various embodiments.

FIG. 21 is a flow diagram of an example method of performing support operations, in accordance with various embodiments.

### DETAILED DESCRIPTION

Disclosed herein are chromatography support systems, as well as related methods, computing devices, and computer-readable media. For example, in some embodiments, the systems and methods disclosed herein may enable the automatic identification of error or fault conditions, prediction of error/fault conditions, and/or self-recovery in response to error/fault conditions in a chromatography system without the need for offline evaluation or complex diagnostics run by an expert user. An example method may comprise determining sensor data for one or more sensors of a chromatography device. The method may comprise determining, based on the sensor data and a computational model (which may include, for example, a machine-learning model), one or more classifications associated with the sensor data (e.g., a pulse classification for at least a portion of a plurality of pulsations associated with the sensor data). The computational model may classify portions of the sensor data or data calculated based on the sensor data (e.g., pulsations) according to one or more of a plurality of states associated with the chromatography device. The example method may comprise determining, based on at least a portion of the one or more classifications (e.g., pulse classifications), an operational status associated with the chromatography device. The example method may comprise storing an indication of the operational status (e.g., in a local or remote service log for use by service technicians, by setting a software flag, and/or by setting a value of a variable that may be provided to a user of the chromatography device via a graphical user interface, warning light, warning sound or other user interface element).

The chromatography support embodiments disclosed herein may achieve improved performance relative to conventional approaches. For example, in some embodiments, the systems and methods disclosed herein may evaluate pump-related data (e.g., pressure, leak sensor data, time, pre-compression data, electric current, drive position data, temperature, etc.) and optionally data from the detector or other modules of the chromatography system (e.g., retention time data of the analysis peaks) to generate references or models that allow the identification of error conditions. The embodiments disclosed herein thus provide improvements to chromatography technology (e.g., improvements in the computer technology supporting chromatography systems, among other improvements).

Advantages of the inventive systems and techniques disclosed herein may include some or all of the following:
Various ones of the systems and methods disclosed herein may be effectively applied regardless of the operating conditions.
Various ones of the systems and methods disclosed herein may not require much or any information from the user. This may avoid the need for the user to define limits for the functioning of the chromatography system (that he or she most likely does not know).
Various ones of the systems and methods disclosed herein may involve the automated recording of data such that an existing analysis run does not have to be interrupted. Instead, error diagnosis may occur parallel to normal operation. This may eliminate or reduce the additional user effort required for error diagnosis and may also leave the system available for analysis.
Various ones of the systems and methods disclosed herein may interpret the data independently and provide an analysis of the system as a diagnostic answer, without the user of the system having to interpret any data.
Various ones of the systems and methods disclosed herein may allow errors in the system to be diagnosed during laboratory operation or during an idle period that is not being used for analytical purposes.
Various ones of the systems and methods disclosed herein may provide interpreted results without the need for expert user knowledge. For example, the systems and methods disclosed herein may expressly identify a particular component as likely defective, which may provide a tremendous advantage over the mere display of the measurement results (e.g., leak rate), especially for untrained operating personnel. As the exchange of components is often easy even for untrained users (while identifying a defective component is not), by identifying the defective component, the systems and methods disclosed herein may enable an untrained user to operate the system without substantial additional support.
Various ones of the systems and methods disclosed herein may not require any separate measurement setup to carry out the diagnosis. For example, the user does not have to change the fluidics or replace the fluids in the system.
Various ones of the systems and methods disclosed herein may both detect an error based on signal abnormalities, and may also indicate the type of error and/or component associated with the error, saving time spent troubleshooting and avoiding unnecessary replacement costs.
Various ones of the systems and methods disclosed herein may determine a remaining service life, which may extend maintenance intervals, reduce the number of replacements, and make needed maintenance plannable.
Various ones of the systems and methods disclosed herein may help avoid unplanned downtime of chromatography systems.
Various ones of the systems and methods disclosed herein may increase the overall reliability and analysis quality of a chromatography system while also lowering demands on technical user expertise, resulting in a simultaneous improvement in cost-of-ownership and usability.
Various ones of the systems and methods disclosed herein may evaluate whether an abnormality had a significant influence on an analysis result, resolving doubt about the relevance of an error and reducing the time wasted on inconsequential errors or spurious errors.
Various ones of the systems and methods disclosed herein may not be significantly affected by the aging process of the separation column in the chromatography system.

The embodiments disclosed herein may achieve any of a number of advantages relative to conventional approaches, as discussed herein. Such technical advantages are not achievable by routine and conventional approaches, and all users of systems including such embodiments may benefit from these advantages (e.g., by assisting the user in the performance of a technical task, such as running a chromatographic analysis, by means of a guided human-machine interaction process). The technical features of the embodiments disclosed herein are thus decidedly unconventional in the field of chromatography, as are the combinations of the features of the embodiments disclosed herein. As discussed further herein, various aspects of the embodiments disclosed herein may improve the functionality of a computer itself; for example, a control computer for a chromatography system. The computational and user interface features disclosed herein do not only involve the collection and comparison of information, but apply new analytical and technical techniques to change the operation of a chromatographic system. The present disclosure thus introduces functionality that neither a conventional computing device, nor a human, could perform.

Accordingly, the embodiments of the present disclosure may serve any of a number of technical purposes, such as controlling a specific technical system or process, determining from measurements how to control a machine, providing estimates for maintenance protocols, and providing new and more efficient processing of sensor data.

The embodiments disclosed herein thus provide improvements to chromatographic technology (e.g., improvements in the computer technology supporting chromatography, among other improvements). The systems and methods disclosed herein may be used in a range of health monitoring applications for chromatography and other scientific instruments. For example, various ones of the systems and methods disclosed herein may distinguish between “good” and “bad” sensor data (e.g., “The pressure signal appears abnormal”), name particular component failures (e.g., “The inlet check valve appears to be leaky”), quantize component failures (e.g., “The leak is approximately 0.3% of the total flow (25 microliters per minute)”), generate a health overview of the system (e.g., “The system health regarding the inlet check valve leak is 30%, regarding the outlet check valve leak is 100%, regarding air bubbles is 100% . . . ”), and suggest or trigger remedial or maintenance actions (e.g., “If you are satisfied with your analysis results, do nothing; if not, run a flushing process (or change a particular part, schedule a maintenance call, send a report of the issue to a service team, etc.)”).

In the following detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made, without departing from the scope of the present disclosure. Therefore, the following detailed description is not to be taken in a limiting sense.

Various operations may be described as multiple discrete actions or operations in turn, in a manner that is most helpful in understanding the subject matter disclosed herein. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

For the purposes of the present disclosure, the phrases “A and/or B” and “A or B” mean (A), (B), or (A and B). For the purposes of the present disclosure, the phrases “A, B, and/or C” and “A, B, or C” mean (A), (B), (C), (A and B), (A and C), (B and C), or (A, B, and C). Although some elements may be referred to in the singular (e.g., “a processing device”), any appropriate elements may be represented by multiple instances of that element, and vice versa. For example, a set of operations described as performed by a processing device may be implemented with different ones of the operations performed by different processing devices.

The description uses the phrases “an embodiment,” “various embodiments,” and “some embodiments,” each of which may refer to one or more of the same or different embodiments. Furthermore, the terms “comprising,” “including,” “having,” and the like, as used with respect to embodiments of the present disclosure, are synonymous. When used to describe a range of dimensions, the phrase “between X and Y” represents a range that includes X and Y. As used herein, an “apparatus” may refer to any individual device, collection of devices, part of a device, or collections of parts of devices. As used herein, the phrase “based on” should be understood to mean “based at least in part on,” unless otherwise specified. The drawings are not necessarily to scale.

Chromatography systems are widely used in a number of settings, including quality control. Unplanned failures of a chromatography system may disrupt the process of which they are part (e.g., preventing a process from moving onto a next step, or compromising the reliability of the result of the chromatography analysis). The embodiments disclosed herein may enable the diagnosis of errors in chromatography systems (e.g., high-performance liquid chromatography (HPLC) systems) during the operation of these systems, reducing unplanned failures.

Conventional approaches to chromatography system management include specification of service intervals for the inspection and/or replacement of components, as well as diagnostic routines that may detect error conditions through special tests. Under the service interval approach, service intervals are typically selected based on an expected service life of an associated component, and more sophisticated conventional approaches take into account the amount or duration of use of the component. Under the special diagnostic test approach, various measurements of the system are taken and compared against limit values, with an error condition corresponding to measurements falling outside the limit values. In some diagnostic tests, a manufacturer of a chromatography system may only specify a measurement method, but may not specify associated limit values. The evaluation of the measurements may instead be left up to manual evaluation by an experienced user, who may rely solely on his or her experience or training.

These conventional approaches to chromatography system management are associated with a number of drawbacks. Service intervals for the replacement of worn components may be based on “standard” or “proper” use of the component, but the wear on a component may depend strongly on the particular uses to which the chromatography system has been put. For example, the wear on a component of a chromatography system may depend on the solvents used, the amount of time per week that the chromatography system is in operation, the particular requirements for the accuracy of the chromatography system, and/or the cleanliness of the chromatography system, among others. If components are properly functioning are replaced solely due to age, unnecessary costs and downtime are incurred. Conversely, if excessively worn components are not replaced because the service interval has not yet been met, the result may be the failure of the chromatography system to deliver reliable results.

Diagnostic tests usually require an experienced user or service technician to carry out, and nearly always require the interruption of the productive use of the chromatography system, making the system unavailable to perform the sample analyses that its users wish to perform. Interpreting the results of diagnostic tests can also require significant technical knowledge, which is not always available among the users of a chromatography system or is associated with expensive and time-consuming technical training. For a service technician, it may be faster to simply replace components or even entire sub-assemblies than to carry out complex diagnostic routines that will require detailed analysis. The limit values associated with a particular diagnostic test may be set universally and statically, and thus may be set to accommodate a wide range of uses of the chromatography system and to avoid the creation of false error messages. Additionally, the determination of appropriate limit values may be based on tests carried out on only a few systems, which may mean that the performance of not all systems under all conditions may have been considered. A diagnostic test is typically defined by a test description or a short instruction in a user manual, and a user must follow these instructions correctly in order to properly carry out the test. If a user performs a test improperly, or if an adequately experienced user is not available to perform the test, errors may not be detected. Because of their need to be carried out by a user, conventional diagnostic tests typically rely on only a few measurements, neglecting the information that may be provided by additional measurements and/or values of “hidden” sensors. Further, as noted above, conventional chromatography systems typically must be taken “offline” to perform diagnostic tests, with such “downtime” slowing the processes for which the chromatography systems play a role.

Many operational errors of chromatography systems (e.g., bearing damage, seal leakage, contamination of ball valves, etc.) are caused by wear and typically do not lead to an immediate failure. Various ones of the embodiments of chromatography support systems and methods disclosed herein utilize the observation that, before such errors become so critical that the application suffers, these errors may be reflected in abnormalities in measurements (e.g., in pump pressure data) that have not been conventionally used for error diagnosis. In various ones of the embodiments disclosed herein, such abnormalities may be recognized, quantified, associated with errors in particular components, and/or communicated to a user of the chromatography system. In some embodiments, this error information may be used to trigger the replacement or repair of a failed or failing component at an early stage and/or to individualize recommended maintenance intervals to better fit the operation and uses of a particular chromatography system.

As discussed above, the systems and methods disclosed herein may detect abnormalities in measurements not typically used for error diagnosis. Such measurements may include data that is typically generated during operation of a chromatography system, but that is conventionally discarded. Instead, in various ones of the embodiments disclosed herein, this data may be stored (e.g., automatically, without user instruction to do so, during regular operation). Analysis of this stored data may be performed in the “background” of productive use of the chromatography system (e.g., while the device is being used to perform chromatographic analysis), avoiding system “downtime” and allowing errors to be detected faster. Further, the automatic retention of such data during normal operation of a chromatography system may avoid the need for a user to perform special diagnostic procedures or otherwise generate or retrieve data records whose absence prevents the performance of a proper assessment. Such automatic retention of data may also occur while a chromatography system is in a “standby” mode. In standby mode, one or more of the components of the system may be in a power conservation mode or other similar state requiring less resources than the component typically uses to perform analysis operations in a normal operation mode. In standby mode, the components may be ready to perform analysis operations and waiting for an instruction to do so. Because the operation in standby mode is similar to that of a full operational mode, measurements made during standby mode may be used to assess the state of the chromatography system and detect errors in accordance with the techniques disclosed herein.

The automatic error detection, error quantification, abnormality characterization, and error elimination techniques disclosed herein may also be used to recommend the replacement or repair of components of a chromatography system. In addition to abnormalities caused by faulty components, the techniques disclosed herein may detect run-related disturbances (e.g., air sucked in). The techniques disclosed herein may distinguish between innocuous abnormalities and abnormalities that represent errors that may have consequences for the reliability of the analytical results of the chromatography system. Such error-indicative abnormalities may include a condition under which a component no longer fulfills its intended function and/or when the function of a component or a particular measuring sequences is outside of an accepted tolerance. In some such embodiments, when an abnormality is outside the bounds of an accepted tolerance, then the abnormality may be identified as an error.

In some embodiments, the systems and methods disclosed herein may include the determination of appropriate service intervals for one or more components based on measurement data, and the use of those service intervals for such components in constructing a service interval schedule. Tolerances and limit values determined or utilized by the systems and methods disclosed herein may be based on data from one or more chromatography systems, and/or may be based on historical or current measurement data. Some tolerances and limit values may be made available to a user for manual adjustment (e.g., for a particular analysis or application to achieve a desired quality) or may be adjusted based on reference measurements. In some embodiments, the systems and methods disclosed herein may generate limit values and/or tolerances (e.g., for a particular analysis based on previous results or measurement data associated with that type of analysis).

To evaluate the condition of a chromatography system, measurement data from existing sensors or other monitoring signals used may be used. In some embodiments, additional sensors may be integrated into a chromatography system, and/or existing sensors may be augmented or improved. The data from these existing, new, and/or improved sensors may be used in the systems and techniques disclosed herein. The systems and techniques disclosed herein may evaluate these signals by reading out individual sensors and individually evaluating the signals, combining multiple sensor signals, calculating values based on individual or combined and evaluating the values (e.g., in combination and/or individually), using sensor signals from different chromatography systems, and/or calculating and evaluating statistical properties of sensor signals, among others. The totality of this data may be referred to as the telemetry of a chromatography system. Examples of particular telemetry elements that may be used (e.g., evaluated using classifiers of a model and/or classification rules) by the systems and techniques disclosed herein for error identification in a chromatography system may include, but are not limited to, one or more of the following:
time information: chromatography systems (and potentially individual components) may include a clock so that sensor signals can be tracked as a function of time;
electrical currents and/or voltages: chromatography systems may include one or more sensors for measuring internal currents and/or voltages, representing power consumption, mechanical loading, and/or electrical loading (e.g., possibly indicating malfunctions or failures);
position information: the positions of drive motors may be recorded, indicating the status of the running of a drive or the position of a drive (e.g., pump drives or valve positions in samplers or ovens);
leak sensors: sensors in the chromatography system or any associated fluidics systems may detect leaking liquids and thus indicate the existence of a leak; for example, a leak sensor in a leak pan may indicate that there is a leaking capillary connection in the chromatography system, and/or a DROP sensor may allow a specific measurement of a leak in an associated seal; and/or pressure: pressure sensors may allow the measurement of the real flow in a chromatography system (e.g., taking into account the column resistance). The time course of a pressure signal may be correlated with position information to identify abnormalities that indicate a pump malfunction. As used herein, the term “pump” should be understood to include any device that provides a mobile phase (e.g., one or more solvents, in a temporally constant or time-varying mixture) to carry the analyte through the column. In connection with the indication of the drive position, and after analysis of the temporal severity of the abnormality, the systems and methods disclosed herein may identify the nature of the error. The systems and methods disclosed herein may also identify the frequency of an abnormality, indicating a service life of an associated component. The deviation of pressure from a reference pressure curve may provide information about the size and the effects of an abnormality. In some embodiments, the systems and methods disclosed herein may compare retention times and pulsation within a chromatography system (merging data from the detector of the chromatography system and the pump). A comparison of the shift of retention times, measured by the detector, and abnormalities in the flow, measured by pump data, may be used by the systems and methods disclosed herein to assess a state of the chromatography system. In some embodiments, the systems and methods disclosed herein may compare pulsation with an ultraviolet (UV) baseline, with the UV trace of the detector compared to the pulsation to determine whether a disturbance with the periodicity of pump pressure is present (indicative of a potential problem with the pump). In some embodiments, the systems and methods disclosed herein may compare the sampler valve position and pressure valve data (e.g., merging data from the sampler and the pump). The position of the sampler valve may correspond to different pressure levels, the evaluation of which may allow the systems and methods disclosed herein to identify a sampler blockage error condition. In some embodiments, the systems and methods disclosed herein may detect non-periodic, short-term disturbances in the pressure data. If the pressure signal exhibits deviations from the setpoint that do not match the periodicity of the pump drive, the systems and methods disclosed herein may indicate an error with one or more components in the fluidic path (e.g., particles in the sampler valve have dissolved, risking failure of the valve). In some embodiments, the systems and methods disclosed herein may detect non-periodic, long-term disturbances in the pressure data. If the pressure signal exhibits such deviations from the setpoint that do not correspond to the periodicity of the pump drive, then one or more components in the fluidic path may not be functioning properly (e.g., the temperature control in the oven may be malfunctioning, and/or the pre-filters of the separation column may be clogged). In some embodiments, the systems and methods disclosed herein may correlate the pressure deviations with the temperature signal of the oven to identify errors in the temperature control; if there are no deviations in the temperature signal, then the systems and methods disclosed herein may indicate clogging of the pre-filters of the column. If these disturbances are accompanied by a shift in retention times, the systems and methods disclosed herein may exclude leaks in the pump (e.g., because they are not periodic, and the pressure changes do not coincide with characteristic drive positions), and thus indicate that the leak is somewhere else in the system. In some embodiments, the systems and methods disclosed herein may use pressure signals in conjunction with temperature signals, and/or pressure signals in conjunction with flow sensor signals (e.g., to compare the flow of the pump with the pressure curve and/or the drive position), in order to determine a status of a chromatography system.

In some embodiments, the systems and methods disclosed herein may implement a computational model (e.g., a machine-learning model, as discussed further below) that receives a pressure signal (e.g., and potentially other inputs, as discussed herein) and outputs an identification of one or more detected conditions, such as one or more flow abnormalities and/or mixing errors. Based on this output, the systems and methods disclosed herein may identify effects on the chromatogram or chromatogram areas via the gradient delay time (e.g., defined as the gradient delay volume divided by the flow rate). The determination of a gradient delay time may enable the systems and methods to determine or suggest appropriate limit values for various abnormalities. Further, the systems and methods disclosed herein may be used in an “inverse” manner, to validate a user/technician or automated prediction of a particular error condition by assessing whether an abnormality in one or more measurement signals is not, partially, or completed due to that error condition (e.g., a pump malfunction). Such a use of the systems and methods disclosed herein may reduce the number of false error messages and/or non-specific error messages, reducing unnecessary downtime and also reducing the time needed to resolve an error.

One of the underlying challenges addressed by the systems and methods disclosed herein is to decide when an abnormality is an error. If an abnormality is an error, it may be reported via one or more notifications, alerts, messages, and/or the like. In some cases, a user action may be requested to resolve the error. A further challenge is the task of preserving the data used to make this decision, and turning that data into relevant quantities via assessment (e.g., a task made complex by the quantities of available data and the determination of limit values under highly variable operating conditions). Because a user is free to choose which application he or she runs with a chromatography system, the general operating conditions of such a system are typically unknown a priori, and thus so may be the extent of the abnormalities (e.g., and their effects). Because of this high variance, the systems and methods disclosed herein may use the following technique for creating a reference pressure that may be used to assess the performance of the system during operation. Although this technique is discussed with reference to pressure data for ease of illustration, analogous techniques may be used for other chromatography system data.

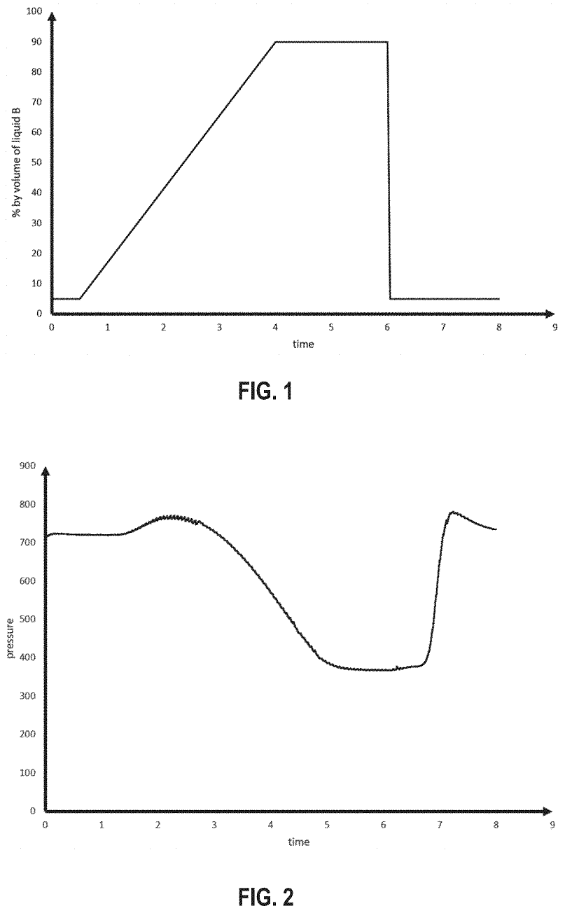

In the event that there is no abnormality or error because the chromatography system is functioning properly, the operating pressure curve also serves as the reference curve. Such a pressure curve may depend on the given gradient shaping and the separation column used. The temporal course is usually not constant, but exhibits changes in pressure, which can be attributed to the mixing gradient. Now consider, for example, a leak in the pump of a chromatography system. A leak is an example of one of the possible abnormalities that the systems and techniques disclosed herein may identify, with other examples including air sucked in, filters or other components clogged, a wrong solvent used as an eluent, particles released by a component, or a combination thereof. The use of a leak for this illustrative example is only one of many errors that may be identified using the techniques disclosed herein. Under non-error conditions, a flow is conveyed by the pump, with the separation column located in the same subsystem. The separation column separates the analytes that are to be examined by the chromatography system, as known in the art. The flow of the pump, the mixing ratio (e.g., as illustrated in FIG. 1), and the flow resistance of the separation column determine the pressure between the pump and the separation column (e.g., as illustrated in FIG. 2). In particular, FIG. 1 illustrates a typical example of a course of the mixing ratio when mixing two liquids, A and B, through the pump, and FIG. 2 illustrates a typical pressure curve obtained during the mixing of FIG. 1.

In an ideal state, the pressure may be the same at all points between the pump and the separation column, and may be measured by the pressure sensor in the pump. If a leak occurs in the pump (e.g., because a component is defective), then part of the flow is diverted via this leak. This partial flow is now missing from the full flow towards the separation column, and a pressure change may result. The systems and methods disclosed herein may recognize that a leak provides a negative flow contribution, and thus the pressure associated with a leak may be below the expected level of a leak-free condition. The size or influence of the leak may not be constant. For example, the influence of the leak may depend on which phase of the drive cycle the drive is in. The phase of the drive cycle may be represented by the position indication of the drive. Due to the operation of the drive, the position information changes over time, and so the size of the leak may also depend on the drive cycle. Indeed, there may be times in the drive cycle in which the leak has no effect on the chromatography system.

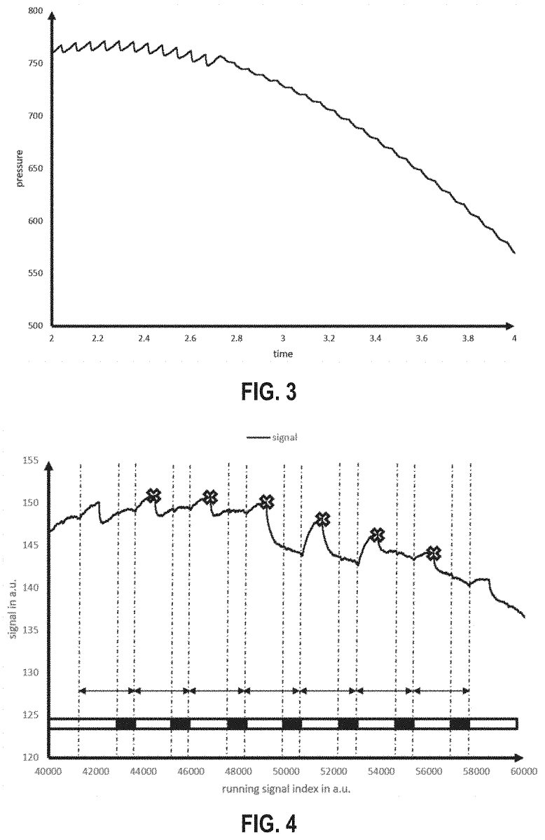

The systems and methods disclosed herein may utilize these observations in any of a number of ways. For example, due to the cyclic operation of the pump, the occurrence of the leak may also be repeated cyclically (as may be the phases during which the leak has no effect, as well as phases during which the operation of the pump experiences a disturbance). For example, FIG. 3 is an enlarged representation of the curve of FIG. 2 in the period between times 2 minutes and 4 minutes. Between 2 minutes and 2.7 minutes, the curve of FIG. 3 shows a regular disturbance, with the regularity coming from the cyclic operation of the pump and the disturbance arising from control of the pump itself. After 2.7 minutes, the control is better and there is little to no disturbance. In order to distinguish between acceptable disturbances and unacceptable abnormalities, the systems and methods disclosed herein may not evaluate the pressure over the entire cycle. Instead, only the section(s) of the cycle during which there are no or few other disturbances may be evaluated in order to more clearly reveal the effects of the abnormality of interest (e.g., the leak). For example, FIG. 4 is a representation of a cyclic pressure signal, with each cycle (indicated by the double-headed arrows) having a section that will be evaluated for abnormalities (indicated in white) or will not be evaluated for abnormalities (indicated in black). Note that the maxima (indicated by crosses) are in the white sections.

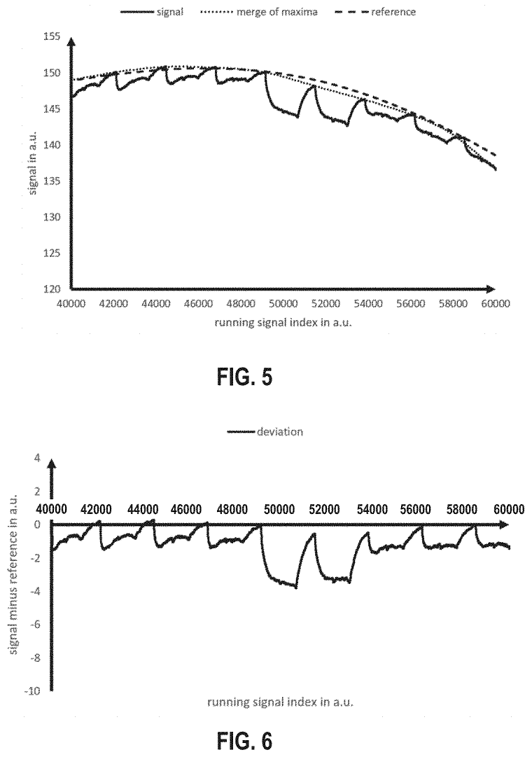

The effect of a leak may not be immediate, but may take some time to affect a chromatography system. Because the effort may be measured via pressure, compressibility may also play a role. This may mean that if the size of a leak changes in time through the cycle, the pressure also changes, but may be somewhat delayed in time. The pressure may not immediately follow the flow (minus the leak), but may lag behind. An example of this phenomenon that may be recognized by the systems and methods disclosed herein is that the flow minus the leak may look like a rectangular pulse function, and the pressure curve may follow a triangular pulse function. An analogy may be a charging/discharging capacitor that is connected to a time-dependent voltage with the capacitor current being recorded. Thus, in the case of a time-dependent leak during a cycle, the pump may measure a time-dependent course of the pressure. In the selected section of a pressure curve, this course may also be time-dependent (if the effects are still observable), but the maximum pressure absolutely measured in such sections may have the closest value to the pressure value of the leak-free “ideal” pump. This value may thus be used as a representative value for one cycle. This may be done for many consecutive pumping cycles, with the result being a sequence of pressure values that are all close to the “ideal” value. When one or more of these pressure values are outliers, the systems and methods disclosed herein may recognize them (e.g., by comparing them with neighboring values). The outlier values may be replaced with interpolated or other “smoothed” values. Consequently, the sequence of pressure values may be merged into a smoothed sequence of pressure values, with this smoothed curve being close to the “ideal” pressure curve of the pump (e.g., the curve that would be exhibited in the absence of a leak), and thus the smoothed curve may serve as a reference curve against which abnormalities can be tested by the systems and methods disclosed herein. FIG. 5 illustrates an example of such a smoothed reference curve generated from a measured pressure signal. In some embodiments, the systems and methods disclosed herein may subtract the reference curve from the measured pressure signal to reveal the deviation of the pressure from the “ideal” course (e.g., as illustrated in FIG. 6), without the confounding influences of the mixing ratio or the flow resistance.

Some embodiments of the systems and methods disclosed herein may apply a single-stroke approach (SSA) or a multi-stroke approach (MSA) for further evaluation of a pressure signal. In an SSA, the deviation of the pressure may be evaluated individually for each cycle, allowing a per-cycle determination of a maximum deviation of the pressure from the ideal and a time at which this maximum deviation occurred. Because this time may be identified in relation to the drive cycle (e.g., the phase of the drive or the drive position), the deviation can be characterized algorithmically. The systems and methods disclosed herein may use this time information, in addition to the size of the deviation, in determining whether an error has occurred.

In an MSA, the deviation of the pressure may be recorded per cycle, but several consecutive cycles may be averaged (e.g., weighted-averaged). The result may be an averaged pressure deviation over the set of cycles. The result may be compared with a reference using methods of statistics or machine-learning. For example, the shape of the deviation and other data, such as slope, regression, noise ratio, etc., may be used for evaluation. A suitable reference may represent a signal associated with a known abnormality. If an averaged pressure signal corresponds to such a reference with high probability (e.g., exceeding a limit value), then the systems and methods disclosed herein may identify the presence of the known abnormality and can be reported as an error. In some embodiments, machine-learning models may be trained on such references to identify when a signal corresponds to a particular reference (and thus represents a particular abnormality). Such machine-learning models may improve over the course of operation of a chromatography system as more training data is generated and used to adapt the model to the particular applications, operating conditions, or user preferences for the chromatography system. For example, user preferences may be derived by receiving user input on maintenance intervals. MSA itself may be an improvement over conventional methodologies. By summing up pump troughs, artifacts and the typically dominant control errors may be averaged out, enabling flow/mixing errors to be recognized and quantified. If flow/mixing error quantification takes place in the gradient phase, chromatographic effects can be inferred, and a user can be alerted or the results compensated accordingly.

An OSA may detect errors per cycle and may do so more quickly than an MSA. However, an OSA may also “over-detect” errors, identifying those that have little effect on the ultimate analysis results of the chromatography system. An MSA may detect abnormalities in a targeted manner, but an error must occur more frequently in order to be recognized. In various embodiments, the systems and methods disclosed herein may implement OSA and MSA to effectively identify the frequencies and timing of abnormalities. The systems and methods disclosed herein may use the frequency of occurrence of a fault to generate (e.g., by extrapolation) a time at which a component is expected to fail. The systems and methods disclosed herein may use abnormality timing information to divide time into relevant and non-relevant portions (e.g., there may be little need for action if the abnormalities always occur in the washing phase of a chromatography process, but there may be an increased need for action if abnormalities occur early in a gradient phase). The systems and methods disclosed herein may utilize the frequency of occurrence of an abnormality as a validation or threshold for whether the abnormality is an error. For example, in order to avoid premature error messages, the systems and methods disclosed herein may not report a non-critical abnormality when it is first identified. If the associated component is actually defective, or on its way to failing, the condition of the component will typically deteriorate further, and the frequency of occurrence of the associated abnormality will increase (e.g., increasing the probability that the abnormality will be reported as an error). Some errors, like air in the pump, may be relatively easy for the systems and methods disclosed herein to detect, but these detected errors may not be accompanied by an error message (e.g., because air can remove itself from the pump without intervention by a user). In such a case, only a message about the occurrence of the error to the user may be provided, but no further intervention of the user may be requested. In some embodiments, the systems and methods disclosed herein may use the analysis output by the chromatography system (e.g., peak shift data) to identify one or more periods in which an error in the chromatography system may be expected and/or searched for.

As noted above, the use of a pressure curve in various ones of the examples disclosed herein is simply illustrative, and the techniques disclosed herein may be applied to other signals in a chromatography system. In some embodiments, the systems and methods disclosed herein may not use a generic model or algorithm to evaluate its performance, but may generate an application-specific model, a device-specific model, and/or a time-specific model based on the use of the associated chromatography system. In some embodiments, a new customized model may be generated with each measurement process, with older measurements discarded and the model adjusted in view of more recent measurements.

The systems and methods disclosed herein may be implemented using any of the logic, processing devices, computing devices, and/or computing systems disclosed herein (e.g., a computing device that is embedded in a chromatography system, external to a chromatography system, in communication with a chromatography system, or a combination thereof).

The systems and methods disclosed herein may implement any of a number of algorithmic models and/or methods to assess the measurement data, including artificial intelligence (e.g., machine-learning, such as neural networks, deep learning, etc.), statistical methods, probabilistic methods, calculus-based methods, interpolation/extrapolation, conditional programming, any combination thereof, and other mathematical techniques or approaches.

In some embodiments, the systems and methods disclosed herein may be in communication with other systems/methods that perform equivalent analyses, so that it is possible to detect the deviation of a single system from the majority of the other systems, because each system can exchange comparative data with the others and/or because the majority of the systems together provide a reference for the decision model for error detection. One or more computing devices (e.g., servers) may be configured to manage a plurality of chromatography systems (e.g., by comparison of data from multiple systems, generating models based on the plurality of chromatography systems, etc)

In some embodiments, a system may use a reference that is defined as a permissible reference for the system or one of the devices in the system. If a tolerance to this reference is exceeded, an error may be reported or characterized.

In some embodiments, the system independently creates a reference and reports an error if there is too much deviation between two steps, especially successive steps, during step-by-step application of the model.

In some embodiments, an evaluation does not take place at the same time as the course of the analysis, but takes place at a later time and the result is submitted later.

In some embodiments, the data of the system is exported and stored on a computing or storage unit for evaluation. This data is then accessed outside the receiving system and the data is evaluated.

In some embodiments, devices in the system evaluate their data only for themselves and do not exchange data with each other.

In some embodiments, devices summarize data for simplified manual evaluation.

In some embodiments, when the system detects an error, it does not report the error, but in the event that the system is able to correct the error independently, it corrects the error and continues the measurement or repeats the measurement defective by the error.

In some embodiments, the system does not detect an error from the directly available measured value, but records another second measured value, on which the first measured value depends, and thus identifies a defective component that would influence the first measured value.

In some embodiments, the system is able to automatically switch from the normal operation of the analysis to a diagnostic operation with separate and suitable fluidics in order to obtain the data for the evaluation of the system.

In some embodiments, the system does not check against a reference, but translates the signal deviations into values so that they are easier for the user to read. The history of the values can also be recorded. The signal deviations can also be evaluated against the possible or actual effects on the analysis results.

A particular example embodiment will now be described in further detail. This embodiment may be discussed with reference to the use of pump data (e.g., the pressure trace of an HPLC pump) to detect and classify the most common pump failures, but this is simply illustrative, and the methods discussed herein may be suitably applied to any of a number of subsystems and/or different types of data of a chromatography system. As noted above, conventional chromatography troubleshooting routines typically require the user to shut down the system after the user observes some undesirable behavior. The particular embodiment that will be described may check (e.g., and classify) the pump operation qualities a) during normal chromatography system operation and/or b) without having a prior suspicion (i.e. before running in trouble and having a user or technician perform an assessment).

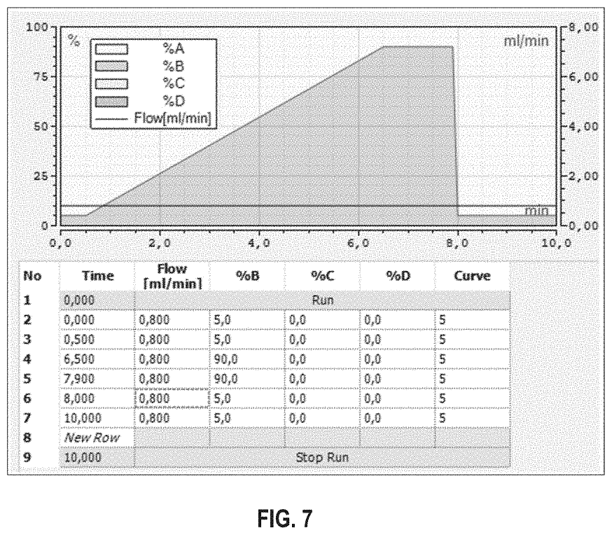

FIG. 7 illustrates an example injection setting in which such an embodiment may operate. An “instrument method” (e.g., a plan for performing a chromatography operation) may define the workflow of an Injection. An example focusing on the pump control commands is shown in FIG. 7. A “gradient profile” for the pump may be defined (e.g., by the user). A “gradient” is the solvent composition definition over time. In this example, the injection starts with pumping 95% water (% A) and 5% acetonitril (ACN) (% B). The flow is constant at 0.8 milliliters per minute. At t=0, the sample is injected into the solvent (e.g., by a sampler module)). The gradient profile of FIG. 7 shows three main stages: a first stage, a second stage, and a third stage. The first stage includes a rising gradient (T=0.5 min . . . 6.5 min), during which the ACN share rises up to 90%. Within this time, the sample is transported (and separated) in the HPLC system. The second stage includes a plateau high %-B (T=6.5 min . . . 7.9 min), during which the system is flushed with a high % B share to remove all remaining components from the separation column. Accurate flow and mixing may be desirable at the second stage, but the second stage may be robust to inaccuracy. The third stage includes a plateau low %-B (T=8 min . . . 10 min), during which system is flushed with a low % B/high % A to re-establish aqueous system conditions for the next injection. It should be understood that this is just one example for purposes of illustration. There are uncountable variations of such methods, gradient profiles, and other parameters. Users may use any appropriate instrument method to analyze a material and/or operate a chromatography device.

The techniques disclosed (e.g., any of the particular embodiments disclosed herein) may be used with any suitable type of pump, such as a low-pressure gradient pump (e.g., 1000 bar, with one pump head, one motor, and one pressure sensor), a camshaft-type high-pressure gradient pump (e.g., 1000 bar, with two pump heads, two motors, and three pressure sensors), a spindle-type high-pressure gradient pump (e.g., 1500 bar, with two pump heads, four motors, and five pressure sensors), or any combination thereof.

One or more of the following may be used as input data:
a pressure profile of a pump (e.g., from pressure sensor(s) of the pump),
a flow profile associated with pump activity and/or flow of liquid through one or more components
other pressure data of the pump (e.g., from other pressure sensors included in the pump and used for control of the pump by firmware),
compression (e.g., from firmware of the chromatography system),
motor position (e.g., defined by the piston position, which also defines a stroke) (e.g., from a rotary encoder at the motor),
DROP counter data (e.g., from a DROP counter, which measures drops arising from, e.g., leakage of one of the seals), and
leak sensor information (e.g., from a sensor similar to a float switch, which alerts when there is leaking solvent in the drip tray).

Note that, in practice, a drop sensor may count drops, but depending upon the hardware design, it may be ambiguous (e.g., based on the drop sensor data alone) as to whether the drops come from a high-pressure sealing failure (e.g., an error that will be characterized by the systems and methods disclosed herein) or from other sources (e.g., the pump needing some additional cleaning liquids).

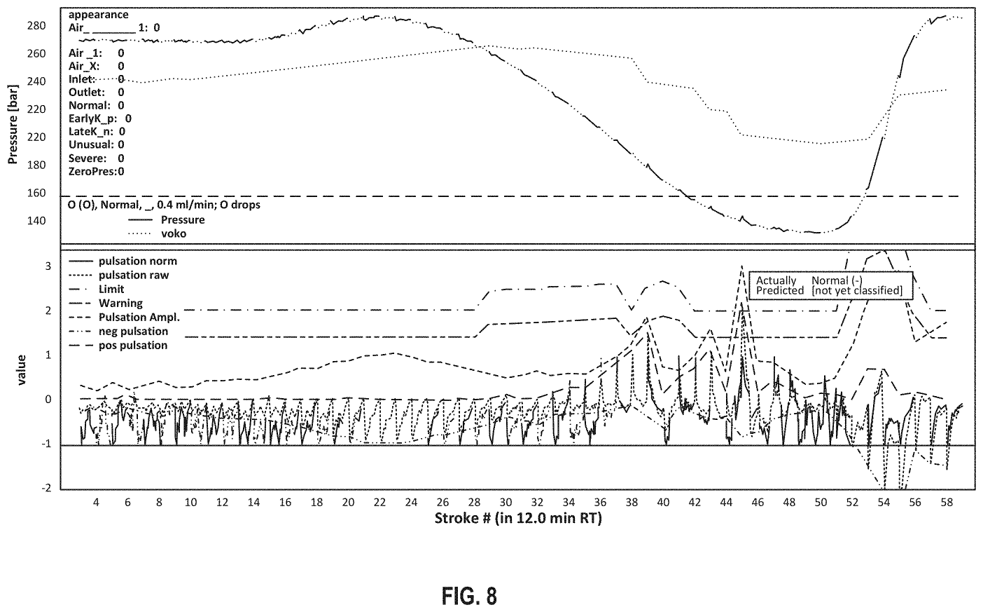

FIG. 8 illustrates a pressure/compression/pulsation signal of a common injection in a chromatography system. The chromatography system may inject a substance (e.g., liquid solutions including a material to analyze) into a component (e.g., a chamber or column), resulting in differentiation in detection of materials. In particular, the upper plot of FIG. 8 illustrates an unprocessed pressure signal as it is received from pressure sensors (darker solid line) and compression information as it is calculated by firmware of the chromatography system (lighter solid line). The lower plot of FIG. 8 illustrates the pulsation signal calculated from the pressure (showing various lines indicating pulsation as a percentage, and pulsation normalized to the range [−1,1]). When an injection is complete, the pump pressure, motor position, and compression signal may be processed.

Compression may comprise data calculated for every stroke by a firmware algorithm. As discussed herein, the compression changes over time, and may be dependent on pressure and solvent composition. The compression value may change slowly in the first half of the injection and then produce compression steps in the second half of the injection. The compression may be later referred to herein as a k-value (e.g., like Kompression in the German language).

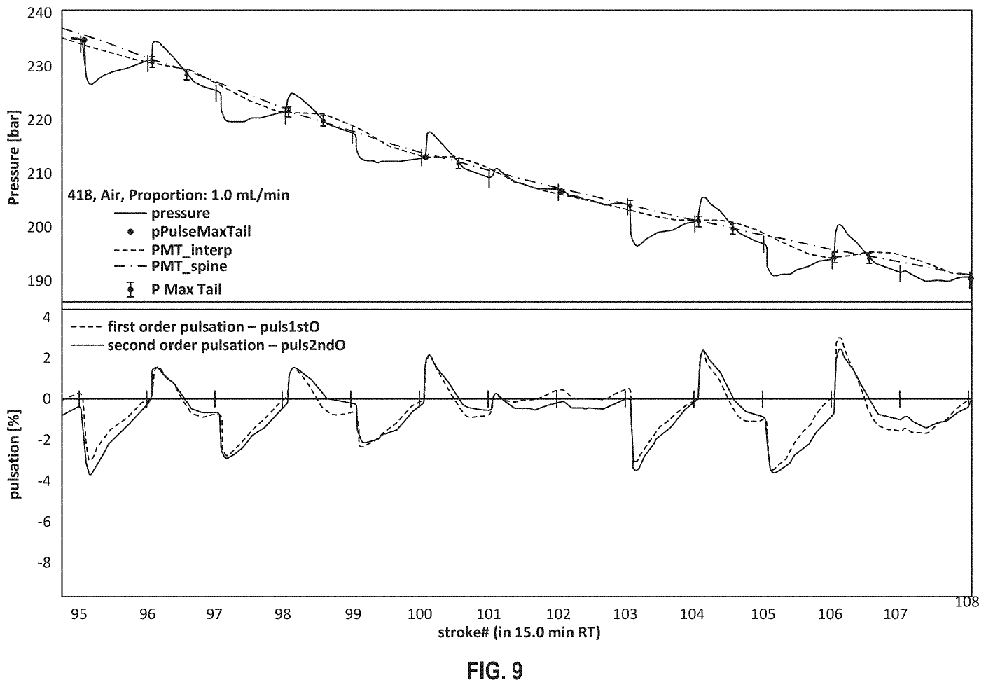

In this embodiment, the systems and methods disclosed herein may determine a pulsation signal based on the pressure signal (e.g., by translating the pressure signal into a pulsation signal). The pulsation signal may represent and/or comprise the pressure signal minus a reference signal. One technique for generating a pulsation signal may include one or more of the following operations (with reference to FIG. 9, which illustrates calculation of the pulsation (the medium dark trace in the lower plot) from the pressure signal (the black trace in the upper plot) from a normal pressure signal, between stroke #96 and stroke #108 of an injection):
1. Divide the pressure signal (e.g., the black trace in the upper plot of FIG. 9) into strokes.
2. As discussed above, one or more segments of a stroke may not be ideal due to the effects of the pump controls, and thus one or more other segments of the stroke (e.g., which are relatively free from the impact of the pump controls) may be further analyzed. For example, in some embodiments, normal control variations are expected at the beginning of the stroke, only at the second half of each stroke may be further analyzed.
3. Calculate a running mean of the pressure (e.g., the lightest trace in the upper plot of FIG. 9) in order to get a first approximation following the normal/expected long-term gradient trend of the pressure profile.
4. Find in each stroke (e.g., in the second half of each stroke) the position where the pressure has its maximum above this first approximation. Those points represent the target pressure for the entire stroke and will later be the knots of an approximation spline (black dots in the upper plot of FIG. 9)
5. Add to each knot an uncertainty which is related to the maximum absolute deviation between the first approximation and the pressure, taking also the first half of the stroke into account (red error bars in the upper plot of FIG. 9)
6. Fit a polynomial (e.g., a second-order polynomial spline) through these targets (e.g., the medium dark trace of the upper plot of FIG. 9)
7. The pulsation may now be defined as the pressure signal minus the fitted polynomial (e.g., the medium dark trace of the lower plot of FIG. 9).

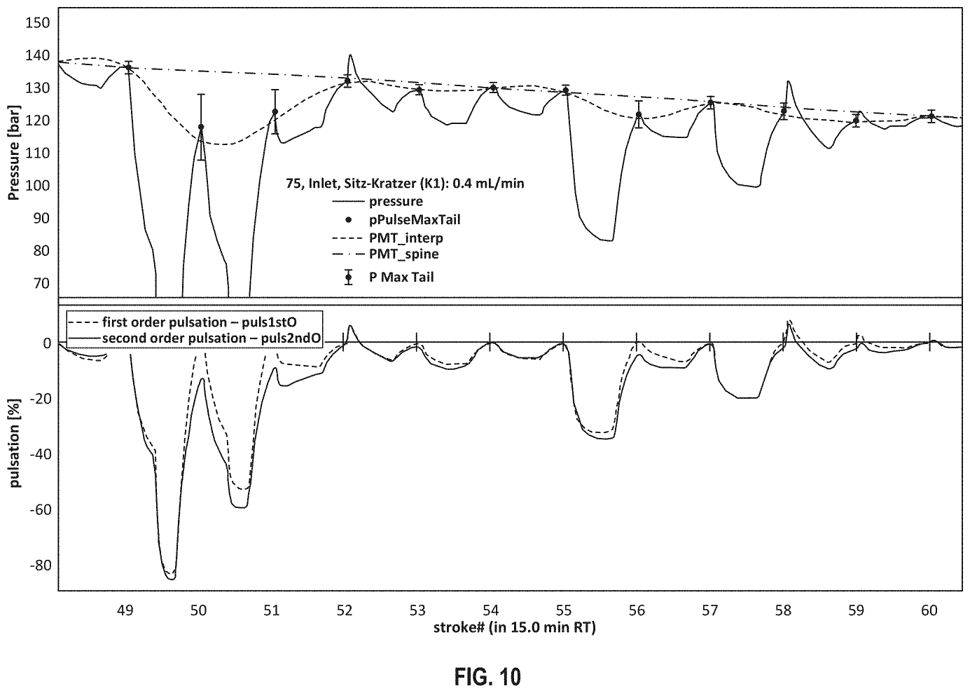

Such an approach to computing pulsation may be particularly appropriate when considering the wide variety of sometimes severe pressure amplitudes associated with different failures occurring in the expected long term pressure slopes of gradient applications. For example, FIG. 10 illustrates a pressure trace and pulsation signal associated with a defective valve. Were a simple running mean used to calculate a pulsation signal from such a pressure trace, the pulsation signal would include many undesirable artifacts.

A machine-learning model may be used to classify each stroke, using data representative of that stroke and also data representative of some of the neighboring strokes. A faulty valve may show a steady pulsation, but an air bubble may appear to come out of nowhere (e.g., the pulsation may be very small prior the stroke where the bubble first occurs). Further, different failures have different impacts on the compression (k-value) calculation. For example, air bubbles may cause high compression changes (since air is very compressible) but even severe outlet check valve failures may have no impact on the k-value.

In the particular embodiment, 88 features may be input to the machine-learning model, with the pulsation (e.g., the medium dark traces in the lower plots of FIGS. 9 and 10) are downsampled to 24 values/features. These particular numbers of features and downsampling frequencies are simply illustrative, and other values may be used. Table 1 below describes the features input to the machine-learning model. In Table 1, “abs” refers to an absolute value, “p” refers to pressure, “lim” refers to a limit, and “warn” refers to a warning.

TABLE 1

| Feature name | Type and Range | Comment |
|---|---|---|
| ‘flow’ | number 0 . . . 8 | flow |
| severeTag’ | bool | is this a severe stroke (pressure change > 50%) |
| zeroPres’ | bool | is this a stroke with less than 50 bar and a high pulsation and a subsequent |
| | | pressure minimum less than 40 bar? |
| ‘kValue’ | number 0 . . . 100 | present k value % |
| ‘kStepPrev’ | number −100 . . . 100 | change from prev. k value in % |
| ‘kStepNext’ | number −100 . . . 100 | change to next k value in % |
| ‘kPrev7Steps’ | number 0 . . . ±10(typ) | abs sum of previous 7 strokes k's |
| ‘kNext7Steps’ | number 0 . . . ±10(typ) | abs sum of next 7 strokes ahead k's |
| ‘kPrev15Steps’ | number 0 . . . ±10(typ) | abs sum of previous 15 strokes k's |
| ‘kNext15Steps’ | number 0 . . . ±10(typ) | abs sum of next 15 strokes ahead k's |
| ‘kRoughAhead | bool | Found a rough k control 7 steps ahead |
| ‘kNowVsPrev7’ | number 0 . . . ±1000(typ) | dividing the now-k step by the maximum of the prev. 7 steps. |
| ‘kStepMean’ | number 0 . . . 5(typ) | the mean k step per stroke of this injection |
| ‘pValue’ | number 0 . . . 1500 | pressure level |
| ‘maxPInInj’ | number 0 . . . 1500 | p max of injection |
| ‘relPmax’ | number 0 . . . 1 | pValue/pmax |
| ‘minPInInj’ | number 0 . . . 1500 | p min of injection |
| ‘relPmin’ | number 0 . . . 1 | pmin/pValue |
| ‘p1stDeriv’ | number −1500 . . . 1500 | delta p to next stroke |
| ‘p2ndDeriv’ | number −1500 . . . 1500 | delta delta p to next stroke |
| ‘pNoise | number 0 . . . 24 | how noisy is the signal |
| ‘pulsValue’ | number 0 . . . 100 | pulsation in percent |
| ‘pulsNegValue’ | number 0 . . . −100 | negative pulsation in percent |
| ‘pulsPosValue’ | number 0 . . . 100 | positive pulsation in percent |
| ‘pulsModerate’ | bool | pulsation is it above 1.2% |
| ‘pulsNegModerate’ | bool | pulsation is it above 1.2% abs. |
| ‘pulsPosModerate’ | bool | pulsation is it above 1.2% abs. |
| ‘pulsDistinct’ | bool | pulsation is it above 7% abs. |
| ‘pulsNegDistinct’ | bool | pulsation is it above 7% abs. |
| ‘pulsPosDistinct’ | bool | pulsation is it above 7% abs. |
| ‘pulsLim’ | number | the pulsation limit |
| ‘pulsWarn’ | number | the pulsation warning limit |
| ‘pulsExceedsWarn’ | bool | pulsation is above the warning limit |
| ‘pulsExceedsLim’ | bool | pulsation is above the limit |
| ‘pulsStepNext1’ | number −100 . . . 100 | pulsation change to 1 strokes' ahead pulsation |
| ‘pulsStepNext2’ | number −100 . . . 100 | pulsation change to 2 strokes' ahead pulsation |
| ‘pulsStepNext3’ | number −100 . . . 100 | pulsation change to 3 strokes' ahead pulsation |
| ‘pulsStepNext5’ | number −100 . . . 100 | pulsation change to 5 strokes' ahead pulsation |
| ‘pulsStepNext10’ | number −100 . . . 100 | pulsation change to 10 strokes' ahead pulsation |
| ‘pulsStepPrev1’ | number −100 . . . 100 | pulsation change from 1 strokes' prev pulsation |
| ‘pulsStepPrev2’ | number −100 . . . 100 | pulsation change from 2 strokes' prev pulsation |
| ‘pulsStepPrev3’ | number −100 . . . 100 | pulsation change from 3 strokes' prev pulsation |
| ‘pulsStepPrev5’ | number −100 . . . 100 | pulsation change from 5 strokes' prev pulsation |
| ‘pulsStepPrev10’ | number −100 . . . 100 | pulsation change from 10 strokes' prev pulsation |
| ‘pulsStepSumNext5’ | number | cumulative pulsation steps in the next 5 strokes. |
| ‘pulsStepSumPrev5’ | number | cumulative pulsation steps in the prev 5 strokes. |
| ‘pulsSumNextVSPrev’ | number | sum of the next five pulsation divided by the sum of the prev five |
| ‘pulsMaxRegion’ | number 0 . . . 100 | pulsation in percent in the injections high-pressure region |
| ‘pulsMinRegion’ | number 0 . . . 100 | pulsation in percent in the injections low-pressure region |
| ‘pulsRegionDiff’ | number 0 . . . 100 | pulsation difference between high- and low-pressure region |
| ‘pulsRegionRelDiff’ | number 0 . . . 100 | pulsation diff between high and low p region relative to current pulsation |
| dropsHourly’ | number 0 . . . inf | hourly count of drops |
| dropsLeakRel’ | number 0 . . . 1 | assumed leakage relative to flow |
| ‘pulsMaxIdx’ | number 0 . . . 24 | at what index is the pulsations maximum |
| ‘pulsMinIdx’ | number 0 . . . 24 | at what index is the pulsations minimum |
| ‘pulsMax_norm’ | number −1 . . . 1 | maximum of normalized pulsation |
| ‘pulsMin_norm’ | number −1 . . . 1 | minimum of normalized pulsation |
| ‘pulsMean_norm’ | number −1 . . . 1 | mean position of pulsation |
| ‘pulsMean1st’ | number 0 . . . 1 | mean value of first third of norm, pulsation |
| ‘pulsMean2nd’ | number 0 . . . 1 | mean value of second third of norm, pulsation |
| ‘pulsMean3rd’ | number 0 . . . 1 | mean value of last third of norm, pulsation |
| ‘pulsDiff1st’ | number −1 . . . 1 | slope of 1st part of pulsation |
| ‘pulsDiff2nd’ | number −1 . . . 1 | slope of 2nd part of pulsation |
| ‘pulsDiff3rd’ | number −1 . . . 1 | slope of 3rd part of pulsation |
| puls_1 | number −1 . . . 1 | normalized pulsation 1st value next to k° |
| puls_2 | number −1 . . . 1 | normalized pulsation 2nd value next to k° |
| puls_3 | number −1 . . . 1 | normalized pulsation 3rd value next to k° |
| puls_4 | number −1 . . . 1 | normalized pulsation 4th value next to k° |
| puls_5 | number −1 . . . 1 | normalized pulsation 5th value next to k° |
| puls_6 | number −1 . . . 1 | normalized pulsation 6th value next to k° |
| puls_7 | number −1 . . . 1 | normalized pulsation 7th value next to k° |
| puls_8 | number −1 . . . 1 | normalized pulsation 8th value next to k° |
| puls_9 | number −1 . . . 1 | normalized pulsation 9th value next to k° |
| puls_10 | number −1 . . . 1 | normalized pulsation 10th value next to k° |
| puls_11 | number −1 . . . 1 | normalized pulsation 11th value next to k° |
| puls_12 | number −1 . . . 1 | normalized pulsation 12th value next to k° |
| puls_13 | number −1 . . . 1 | normalized pulsation 13th value next to k° |
| puls_14 | number −1 . . . 1 | normalized pulsation 14th value next to k° |
| puls_15 | number −1 . . . 1 | normalized pulsation 15th value next to k° |
| puls_16 | number −1 . . . 1 | normalized pulsation 16th value next to k° |
| puls_17 | number −1 . . . 1 | normalized pulsation 17th value next to k° |
| puls_18 | number −1 . . . 1 | normalized pulsation 18th value next to k° |
| puls_19 | number −1 . . . 1 | normalized pulsation 19th value next to k° |
| puls_20 | number −1 . . . 1 | normalized pulsation 20th value next to k° |
| puls_21 | number −1 . . . 1 | normalized pulsation 21st value next to k° |
| puls_22 | number −1 . . . 1 | normalized pulsation 22nd value next to k° |
| puls_23 | number −1 . . . 1 | normalized pulsation 23rd value next to k° |
| puls_24 | number −1 . . . 1 | normalized pulsation 24th value next to k° |

In this particular embodiment, the machine-learning model may have a RandomForestClassifier architecture, as known in the art. This model may include 500 decision trees with a depth of 35, but other suitable models may be used. Other types of machine-learning models may be used. The machine-learning model may comprise one or more of a random forest classifier model, a decision tree-based model, a linear classifier model, a k-nearest neighbor model, a support vector machine, a quadratic classifier, a genetic algorithm based model, a neural network, or a combination thereof.

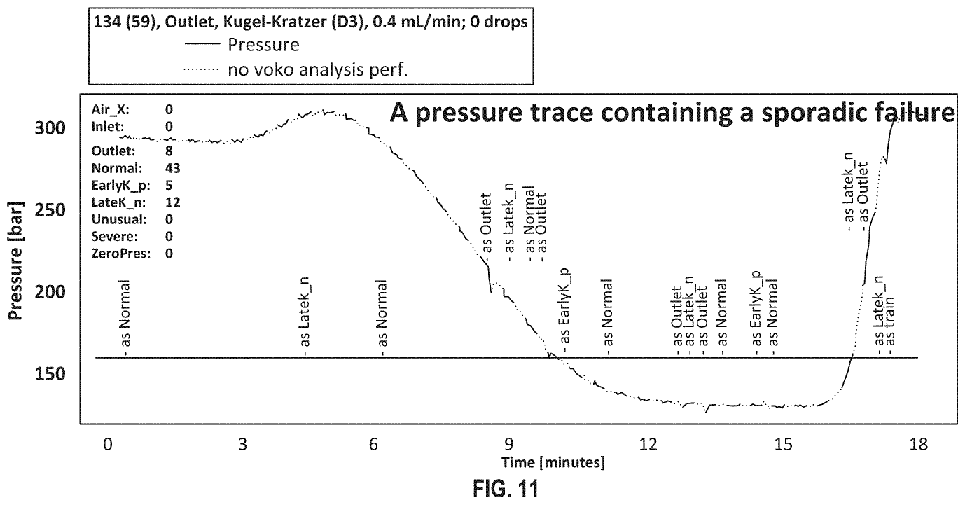

The machine-learning model may output a stroke-wise classification (e.g., of the form “Stroke x has a pulsation of Y$ amplitude as is classified as (failure) type-Z”). Table 2 lists the possible classes of strokes (e.g., pressure classification, variation classification, pulse classification) in this particular embodiment, and FIG. 11 illustrates an example of a possible stroke-wise classification. The top four classes may be considered a first type of classification (e.g., normal, no error conditions). The remaining classes may be considered a second type of classification (e.g., abnormal, error condition).

TABLE 2

| Stroke Classes | Comment |
|---|---|
| Normal | A usual/normal stroke |
| lateK_neg | A usual negative lag of compression control |
| earlyK_pos | A usual positive lag of compression control |
| unusual | An unusual stroke |
| First Piston | Leakage in the first piston |
| Leak (Inlet) | (relabeled later to: Inlet check valve/Seal_1/Leaking fitting) |
| Second Piston | Leakage in the second piston |
| Leak (Outlet) | (relabeled later to: Outlet CV/Seal_2/Leaking fitting) |
| Air_prev | Stroke previous air bubble |
| Air_1 | The first stroke of air bubble |
| Air_X | Strokes after an air bubble |
| Spike | Might be caused by plugging (particles in the liquid) |

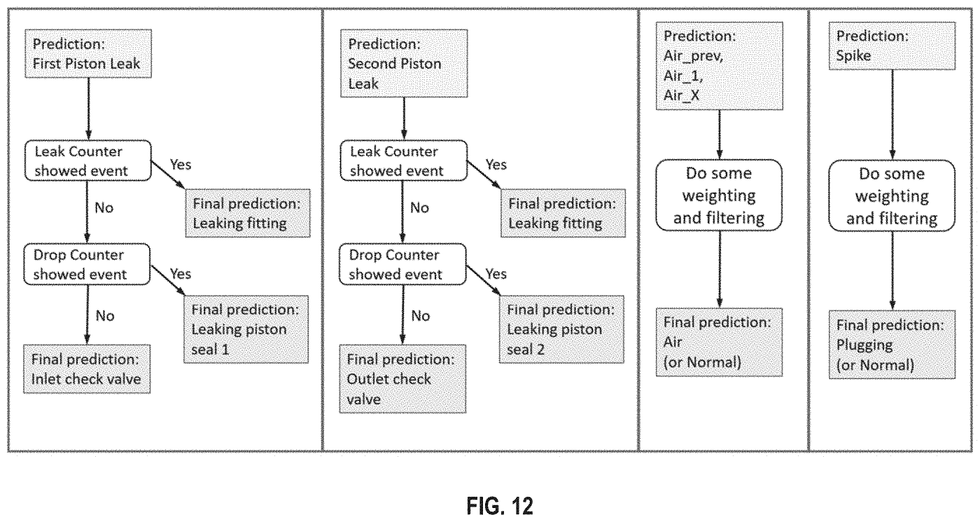

After the machine-learning model is used to output a classification, post-processing may be performed. For example, in the post-processing, the system may determine whether an entire injection is faulty or not based on the stroke-wise classification, weighting algorithms, additional information from other sensors (such as the drop sensor), or a combination thereof. Such post-processing may include one or more of the following steps:
1. Relabel initial stroke classifications using further system information (e.g., from the classes of Table 2 to the classes of Table 3, below, using the process illustrated in FIG. 12)
2. Check if the variation amplitudes exceed certain limits. The fact that one or more strokes might had been classified as, e.g. ‘Outlet check valve failure’ (after re-labeling) does not imply that the entire injection is faulty. In a particular embodiment, the faulty strokes need to reach a certain limit before the entire injection becomes classified as faulty. Such a limit may be set in any of a number of ways, based on user preference, the specific application, and/or the like. One approach is to sum up the pulsation of all faulty classified strokes and see if the sum reaches a certain value or not. However, errors like an air bubble in the stage3-low % B-phase (as illustrated in FIG. 7) may have no impact or substantially no impact on the retention time (e.g., because all peaks had been measured already, and only very little shifts for the next injection might be possible), while an air bubble in stage1-risingGradient-phase (e.g., see FIG. 7) may be much more critical for good retention times. Another approach to identifying an injection failure limit may include one or more of the following:
   a) Sum up pulsation of faulty strokes and check if the sum is above a preset value (e.g., 10% pulsation) and additionally weight failures of certain gradient phases differently, and
   b) Map the pulsations to an assumed retention time shift and check if the assumed shift is below a preset value (e.g., a 1% retention time shift).
   Small detected variations might be used to schedule a maintenance or do a preventive action like purging/flushing the system prior to the next injection. Different injections might have different limits (e.g., in a sequence, there might been more important injections and less important ones, such as injections just used for system conditioning purposes). As a general limit, some embodiments may assume that retention time shifts below 1% are generally accepted and only shifts above 1% may cause an injection to be classified as faulty. In some embodiments, the limit might be set dynamically (e.g., in some system suitable tests, shift limits are defined) or can be adapted by a user. Further, different kind of injections might have different failure limits. Failures in, e.g., blank injections might be less critical than in SST or analysis sample injections.
   Flow and/or mixing inaccuracies may be key reasons for retention time shifts (among others). These inaccuracies may be caused by leakages or, more generally, missing flow (like an air bubble). Pulsation to missing flow may be mapped using the stroke-classification. Missing flow may be calculated for every stroke as follows:

$$\frac{Actual Pressure}{Target Pressure} = \frac{Actual Flow}{Target Flow}$$

The target flow may be known from the injection method file. Then:

Missing Flow=Actual Flow−Target Flow
A mapping from pulsation to mixing inaccuracies may follow the same approach, but may take into account the gradient rising time. Further, different failures may have different impacts on mixing inaccuracies. For example, an air bubble in the % B tubing is definitely a missing flow but may also be a mixing inaccuracy because the missing flow applies only to % B. A leaky seal may be assumed to leak both solvents in same proportions, so there may be a missing flow but no mixing inaccuracy. Finally, mapping from missing flow and mixing inaccuracies to retention time shift may take into account that a temporary failure is only active for a particular time, as follows:

$$failure impact time = \frac{SystemVolume}{flow}$$

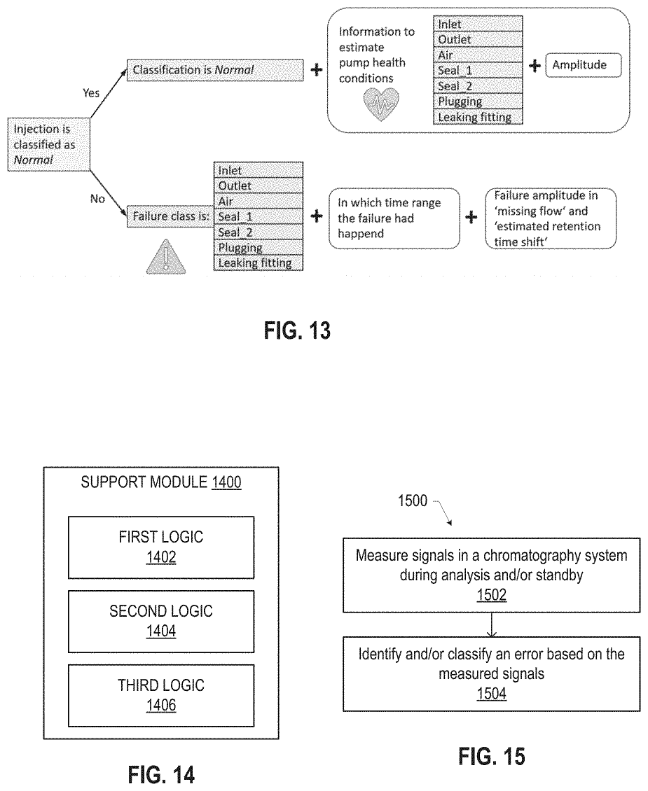

3. Model output definition. The final output may comprise an injection classification. The final output may comprise additional information, such as information about the failure amplitude, time of occurrence, and/or the like. Injection classifications (e.g., operational status) may take the form illustrated in Table 3, below, and in accordance with the flow of FIG. 13.

TABLE 3

| Injection Classes | Comment |
|---|---|
| Normal | A usual/normal injection |
| Inlet | An injection shows an inlet check valve failure |
| Outlet | An injection shows an outlet check valve failure |
| Air | An injection shows an air bubble or empty bottle |
| Seal_1 | An injection with a leaky seal on the first piston |
| Seal_2 | An injection with a leaky seal on the second piston |
| Plugging | Particles or contamination in the system |
| Leaking fitting | A leak at a mechanical connection |

The classifications obtained in the particular embodiment discussed above may be used in a number of ways, including showing warnings, suggesting remedial actions to a user, run (e.g., automatic) further diagnostics, recommend component replacement, providing a predicted time before a component replacement will be mandatory to pass an SST, triggering automatic actions (e.g., running recovery actions, like purging or flushing the system or performing an automatic check valve cleaning procedure, then reinjecting or equilibrating then reinjecting, performing SST recovery actions, or adapting system parameters (e.g., flow), integrating a status display, or scheduling maintenance.

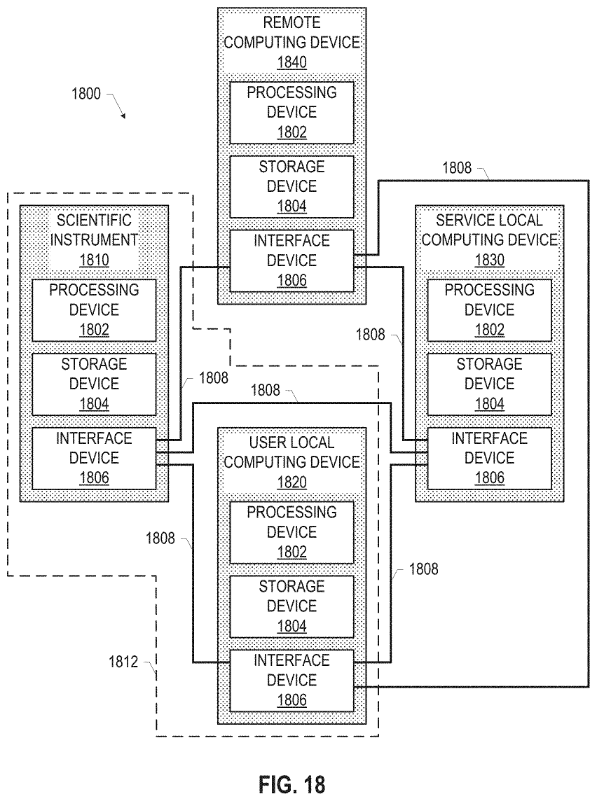

FIG. 14 is a block diagram of a chromatography support module 1400 for performing support operations, in accordance with various embodiments. The chromatography support module 1400 may be implemented by circuitry (e.g., including electrical and/or optical components), such as a programmed computing device. The logic of the chromatography support module 1400 may be included in a single computing device, or may be distributed across multiple computing devices that are in communication with each other as appropriate. Examples of computing devices that may, singly or in combination, implement the chromatography support module 1400 are discussed herein with reference to the computing device 1700 of FIG. 17, and examples of systems of interconnected computing devices, in which the chromatography support module 1400 may be implemented across one or more of the computing devices, is discussed herein with reference to the chromatography support system 1800 of FIG. 18.

The chromatography support module 1400 may include one or more logic elements, such as first logic 1402, second logic 1404, third logic 1406, and/or additional logic. Each of the logical elements may represent logic for implementing one or more steps of FIGS. 15, and 19-21. Separate logic elements may be used to implement separate steps. The logic elements may comprise error detection and classification logic, implemented as one or more of 1402, 1404, 1406, and/or additional logic. As used herein, the term “logic” may include an apparatus that is to perform a set of operations associated with the logic. For example, any of the logic elements included in the support module 1400 may be implemented by one or more computing devices programmed with instructions to cause one or more processing devices of the computing devices to perform the associated set of operations. In a particular embodiment, a logic element may include one or more non-transitory computer-readable media having instructions thereon that, when executed by one or more processing devices of one or more computing devices, cause the one or more computing devices to perform the associated set of operations. As used herein, the term “module” may refer to a collection of one or more logic elements that, together, perform a function associated with the module. Different ones of the logic elements in a module may take the same form or may take different forms. For example, some logic in a module may be implemented by a programmed general-purpose processing device, while other logic in a module may be implemented by an application-specific integrated circuit (ASIC). In another example, different ones of the logic elements in a module may be associated with different sets of instructions executed by one or more processing devices. A module may not include all of the logic elements depicted in the associated drawing; for example, a module may include a subset of the logic elements depicted in the associated drawing when that module is to perform a subset of the operations discussed herein with reference to that module.

The error detection and classification logic (e.g., first logic 1402, second logic 1404, and third logic 1406) may be configured in accordance with any of the techniques disclosed herein to detect and/or classify errors in a chromatography system. For example, the error detection and classification logic may implement any suitable ones of the embodiments disclosed herein.

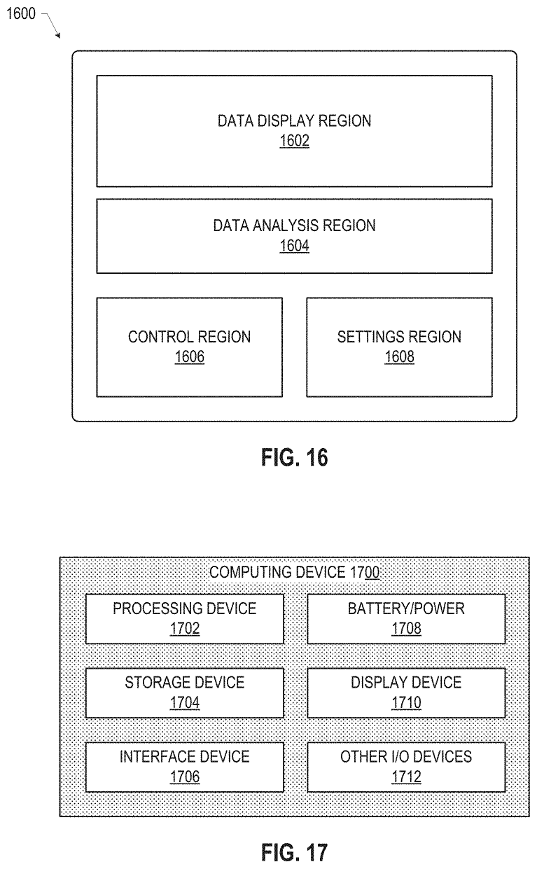

FIG. 15 is a flow diagram of a method 1500 of performing support operations, in accordance with various embodiments. Although the operations of the method 1500 may be illustrated with reference to particular embodiments disclosed herein (e.g., the chromatography support modules 1400 discussed herein with reference to FIG. 14, the GUI 1600 discussed herein with reference to FIG. 16, the computing devices 1700 discussed herein with reference to FIG. 17, and/or the chromatography support system 1800 discussed herein with reference to FIG. 18), the method 1500 may be used in any suitable setting to perform any suitable support operations. Operations are illustrated once each and in a particular order in FIG. 15, but the operations may be reordered and/or repeated as desired and appropriate (e.g., different operations performed may be performed in parallel, as suitable).

At 1502, signals may be measured in a chromatography system during analysis or standby of the system. For example, the error detection and classification logic (e.g., first logic 1402, second logic 1404, third logic 1406, and/or additional logic) of a support module 1400 may perform the operations of 1502. The operations of 1502 may include any suitable ones of the embodiments disclosed herein.

At 1504, an error may be identified and/or classified based on the measured signals. For example, the error detection and classification logic (e.g., first logic 1402, second logic 1404, third logic 1406, and/or additional logic) of a support module 1400 may perform the operations of 1504. The operations of 1504 may include any suitable ones of the embodiments disclosed herein.

The chromatography support methods disclosed herein may include interactions with a human user (e.g., via the user local computing device 1820 discussed herein with reference to FIG. 18). These interactions may include providing information to the user (e.g., information regarding the operation of a chromatography system, such as the chromatography system 1810 of FIG. 18, information regarding a sample being analyzed or other test or measurement performed by a chromatography system, information retrieved from a local or remote database, and/or other information). These interactions may include providing an option for a user to input commands (e.g., to control the operation of a chromatography system such as the chromatography system 1810 of FIG. 18, or to control the analysis of data generated by a chromatography system), queries (e.g., to a local or remote database), or other information. In some embodiments, these interactions may be performed through a graphical user interface (GUI) that includes a visual display on a display device (e.g., the display device 1710 discussed herein with reference to FIG. 17) that provides outputs to the user and/or prompts the user to provide inputs (e.g., via one or more input devices, such as a keyboard, mouse, trackpad, or touchscreen, included in the other I/O devices 1712 discussed herein with reference to FIG. 17). The chromatography support systems disclosed herein may include any suitable GUIs for interaction with a user.

FIG. 16 depicts an example GUI 1600 that may be used in the performance of some or all of the support methods disclosed herein, in accordance with various embodiments. As noted above, the GUI 1600 may be provided on a display device (e.g., the display device 1710 discussed herein with reference to FIG. 17) of a computing device (e.g., the computing device 1700 discussed herein with reference to FIG. 17) of a chromatography support system (e.g., the chromatography support system 1800 discussed herein with reference to FIG. 18), and a user may interact with the GUI 1600 using any suitable input device (e.g., any of the input devices included in the other I/O devices 1712 discussed herein with reference to FIG. 17) and input technique (e.g., movement of a cursor, motion capture, facial recognition, gesture detection, voice recognition, actuation of buttons, etc.).

The GUI 1600 may include a data display region 1602, a data analysis region 1604, a chromatography control region 1606, and a settings region 1608. The particular number and arrangement of regions depicted in FIG. 16 is simply illustrative, and any number and arrangement of regions, including any desired features, may be included in a GUI 1600.

The data display region 1602 may display data generated by a chromatography system (e.g., the chromatography system 1810 discussed herein with reference to FIG. 18). For example, the data display region 1602 may display the results of a chromatographic analysis (e.g., retention times).

The data analysis region 1604 may display the results of data analysis (e.g., the results of analyzing the data illustrated in the data display region 1602 and/or other data). For example, the data analysis region 1604 may display calculated parameters of a chromatographic analysis (e.g., peaks in retention times, peak widths, etc.). In some embodiments, the data display region 1602 and the data analysis region 1604 may be combined in the GUI 1600 (e.g., to include data output from a chromatography system, and some analysis of the data, in a common graph or region).

The chromatography control region 1606 may include options that allow the user to control a chromatography system (e.g., the chromatography system 1810 discussed herein with reference to FIG. 18). For example, the chromatography control region 1606 may include error messages, warning messages, component replacement messages, service messages, options to begin diagnostic or corrective procedures, or other control information or options.

The settings region 1608 may include options that allow the user to control the features and functions of the GUI 1600 (and/or other GUIs) and/or perform common computing operations with respect to the data display region 1602 and data analysis region 1604 (e.g., saving data on a storage device, such as the storage device 1704 discussed herein with reference to FIG. 17, sending data to another user, labeling data, etc.).

As noted above, the chromatography support module 1400 may be implemented by one or more computing devices. FIG. 17 is a block diagram of a computing device 1700 that may perform some or all of the chromatography support methods disclosed herein, in accordance with various embodiments. In some embodiments, the chromatography support module 1400 may be implemented by a single computing device 1700 or by multiple computing devices 1700. Further, as discussed below, a computing device 1700 (or multiple computing devices 1700) that implements the chromatography support module 1400 may be part of one or more of the chromatography system 1810, the user local computing device 1820, the service local computing device 1830, or the remote computing device 1840 of FIG. 18.

The computing device 1700 of FIG. 17 is illustrated as having a number of components, but any one or more of these components may be omitted or duplicated, as suitable for the application and setting. In some embodiments, some or all of the components included in the computing device 1700 may be attached to one or more motherboards and enclosed in a housing (e.g., including plastic, metal, and/or other materials). In some embodiments, some these components may be fabricated onto a single system-on-a-chip (SoC) (e.g., an SoC may include one or more processing devices 1702 and one or more storage devices 1704). Additionally, in various embodiments, the computing device 1700 may not include one or more of the components illustrated in FIG. 17, but may include interface circuitry (not shown) for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device 1700 may not include a display device 1710, but may include display device interface circuitry (e.g., a connector and driver circuitry) to which a display device 1710 may be coupled.

The computing device 1700 may include a processing device 1702 (e.g., one or more processing devices). As used herein, the term “processing device” may refer to any device or portion of a device that processes electronic data from registers and/or memory to transform that electronic data into other electronic data that may be stored in registers and/or memory. The processing device 1702 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing devices.

The computing device 1700 may include a storage device 1704 (e.g., one or more storage devices). The storage device 1704 may include one or more memory devices such as random access memory (RAM) (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some embodiments, the storage device 1704 may include memory that shares a die with a processing device 1702. In such an embodiment, the memory may be used as cache memory and may include embedded dynamic random access memory (eDRAM) or spin transfer torque magnetic random access memory (STT-MRAM), for example. In some embodiments, the storage device 1704 may include non-transitory computer readable media having instructions thereon that, when executed by one or more processing devices (e.g., the processing device 1702), cause the computing device 1700 to perform any appropriate ones of or portions of the methods disclosed herein.

The computing device 1700 may include an interface device 1706 (e.g., one or more interface devices 1706). The interface device 1706 may include one or more communication chips, connectors, and/or other hardware and software to govern communications between the computing device 1700 and other computing devices. For example, the interface device 1706 may include circuitry for managing wireless communications for the transfer of data to and from the computing device 1700. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. Circuitry included in the interface device 1706 for managing wireless communications may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). In some embodiments, circuitry included in the interface device 1706 for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some embodiments, circuitry included in the interface device 1706 for managing wireless communications may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In some embodiments, circuitry included in the interface device 1706 for managing wireless communications may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some embodiments, the interface device 1706 may include one or more antennas (e.g., one or more antenna arrays) to receipt and/or transmission of wireless communications.

In some embodiments, the interface device 1706 may include circuitry for managing wired communications, such as electrical, optical, or any other suitable communication protocols. For example, the interface device 1706 may include circuitry to support communications in accordance with Ethernet technologies. In some embodiments, the interface device 1706 may support both wireless and wired communication, and/or may support multiple wired communication protocols and/or multiple wireless communication protocols. For example, a first set of circuitry of the interface device 1706 may be dedicated to shorter-range wireless communications such as Wi-Fi or Bluetooth, and a second set of circuitry of the interface device 1706 may be dedicated to longer-range wireless communications such as global positioning system (GPS), EDGE, GPRS, CDMA, WiMAX, LTE, EV-DO, or others. In some embodiments, a first set of circuitry of the interface device 1706 may be dedicated to wireless communications, and a second set of circuitry of the interface device 1706 may be dedicated to wired communications.

The computing device 1700 may include battery/power circuitry 1708. The battery/power circuitry 1708 may include one or more energy storage devices (e.g., batteries or capacitors) and/or circuitry for coupling components of the computing device 1700 to an energy source separate from the computing device 1700 (e.g., AC line power).

The computing device 1700 may include a display device 1710 (e.g., multiple display devices). The display device 1710 may include any visual indicators, such as a heads-up display, a computer monitor, a projector, a touchscreen display, a liquid crystal display (LCD), a light-emitting diode display, or a flat panel display.

The computing device 1700 may include other input/output (I/O) devices 1712. The other I/O devices 1712 may include one or more audio output devices (e.g., speakers, headsets, earbuds, alarms, etc.), one or more audio input devices (e.g., microphones or microphone arrays), location devices (e.g., GPS devices in communication with a satellite-based system to receive a location of the computing device 1700, as known in the art), audio codecs, video codecs, printers, sensors (e.g., thermocouples or other temperature sensors, humidity sensors, pressure sensors, vibration sensors, accelerometers, gyroscopes, etc.), image capture devices such as cameras, keyboards, cursor control devices such as a mouse, a stylus, a trackball, or a touchpad, bar code readers, Quick Response (QR) code readers, or radio frequency identification (RFID) readers, for example.

The computing device 1700 may have any suitable form factor for its application and setting, such as a handheld or mobile computing device (e.g., a cell phone, a smart phone, a mobile internet device, a tablet computer, a laptop computer, a netbook computer, an ultrabook computer, a personal digital assistant (PDA), an ultra mobile personal computer, etc.), a desktop computing device, or a server computing device or other networked computing component.

One or more computing devices implementing any of the chromatography support modules or methods disclosed herein may be part of a chromatography support system. FIG. 18 is a block diagram of an example chromatography support system 1800 in which some or all of the chromatography support methods disclosed herein may be performed, in accordance with various embodiments. The chromatography support modules and methods disclosed herein (e.g., the chromatography support module 1400 of FIG. 14 and the method 1500 of FIG. 15) may be implemented by one or more of the chromatography system 1810, the user local computing device 1820, the service local computing device 1830, or the remote computing device 1840 of the chromatography support system 1800.

Any of the chromatography system 1810, the user local computing device 1820, the service local computing device 1830, or the remote computing device 1840 may include any of the embodiments of the computing device 1700 discussed herein with reference to FIG. 17, and any of the chromatography system 1810, the user local computing device 1820, the service local computing device 1830, or the remote computing device 1840 may take the form of any appropriate ones of the embodiments of the computing device 1700 discussed herein with reference to FIG. 17.

The chromatography system 1810, the user local computing device 1820, the service local computing device 1830, or the remote computing device 1840 may each include a processing device 1802, a storage device 1804, and an interface device 1806. The processing device 1802 may take any suitable form, including the form of any of the processing devices 1702 discussed herein with reference to FIG. 4, and the processing devices 1802 included in different ones of the chromatography system 1810, the user local computing device 1820, the service local computing device 1830, or the remote computing device 1840 may take the same form or different forms. The storage device 1804 may take any suitable form, including the form of any of the storage devices 1804 discussed herein with reference to FIG. 4, and the storage devices 1804 included in different ones of the chromatography system 1810, the user local computing device 1820, the service local computing device 1830, or the remote computing device 1840 may take the same form or different forms. The interface device 1806 may take any suitable form, including the form of any of the interface devices 1706 discussed herein with reference to FIG. 4, and the interface devices 1806 included in different ones of the chromatography system 1810, the user local computing device 1820, the service local computing device 1830, or the remote computing device 1840 may take the same form or different forms.

The chromatography system 1810, the user local computing device 1820, the service local computing device 1830, and the remote computing device 1840 may be in communication with other elements of the chromatography support system 1800 via communication pathways 1808. The communication pathways 1808 may communicatively couple the interface devices 1806 of different ones of the elements of the chromatography support system 1800, as shown, and may be wired or wireless communication pathways (e.g., in accordance with any of the communication techniques discussed herein with reference to the interface devices 1706 of the computing device 1700 of FIG. 17). The particular chromatography support system 1800 depicted in FIG. 18 includes communication pathways between each pair of the chromatography system 1810, the user local computing device 1820, the service local computing device 1830, and the remote computing device 1840, but this “fully connected” implementation is simply illustrative, and in various embodiments, various ones of the communication pathways 1808 may be absent. For example, in some embodiments, a service local computing device 1830 may not have a direct communication pathway 1808 between its interface device 1806 and the interface device 1806 of the chromatography system 1810, but may instead communicate with the chromatography system 1810 via the communication pathway 1808 between the service local computing device 1830 and the user local computing device 1820 and the communication pathway 1808 between the user local computing device 1820 and the chromatography system 1810.

The chromatography system 1810 may include any appropriate chromatography apparatus, such as an HPLC system or another chromatography system.

The user local computing device 1820 may be a computing device (e.g., in accordance with any of the embodiments of the computing device 1700 discussed herein) that is local to a user of the chromatography system 1810. In some embodiments, the user local computing device 1820 may also be local to the chromatography system 1810, but this need not be the case; for example, a user local computing device 1820 that is in a user's home or office may be remote from, but in communication with, the chromatography system 1810 so that the user may use the user local computing device 1820 to control and/or access data from the chromatography system 1810. In some embodiments, the user local computing device 1820 may be a laptop, smartphone, or tablet device. In some embodiments the user local computing device 1820 may be a portable computing device.

The service local computing device 1830 may be a computing device (e.g., in accordance with any of the embodiments of the computing device 1700 discussed herein) that is local to an entity that services the chromatography system 1810. For example, the service local computing device 1830 may be local to a manufacturer of the chromatography system 1810 or to a third-party service company. In some embodiments, the service local computing device 1830 may communicate with the chromatography system 1810, the user local computing device 1820, and/or the remote computing device 1840 (e.g., via a direct communication pathway 1808 or via multiple “indirect” communication pathways 1808, as discussed above) to receive data regarding the operation of the chromatography system 1810, the user local computing device 1820, and/or the remote computing device 1840 (e.g., the results of self-tests of the chromatography system 1810, calibration coefficients used by the chromatography system 1810, the measurements of sensors associated with the chromatography system 1810, etc.). In some embodiments, the service local computing device 1830 may communicate with the chromatography system 1810, the user local computing device 1820, and/or the remote computing device 1840 (e.g., via a direct communication pathway 1808 or via multiple “indirect” communication pathways 1808, as discussed above) to transmit data to the chromatography system 1810, the user local computing device 1820, and/or the remote computing device 1840 (e.g., to update programmed instructions, such as firmware, in the chromatography system 1810, to initiate the performance of test or calibration sequences in the chromatography system 1810, to update programmed instructions, such as software, in the user local computing device 1820 or the remote computing device 1840, etc.). A user of the chromatography system 1810 may utilize the chromatography system 1810 or the user local computing device 1820 to communicate with the service local computing device 1830 to report a problem with the chromatography system 1810 or the user local computing device 1820, to request a visit from a technician to improve the operation of the chromatography system 1810, to order consumables or replacement parts associated with the chromatography system 1810, or for other purposes.

The remote computing device 1840 may be a computing device (e.g., in accordance with any of the embodiments of the computing device 1700 discussed herein) that is remote from the chromatography system 1810 and/or from the user local computing device 1820. In some embodiments, the remote computing device 1840 may be included in a datacenter or other large-scale server environment. In some embodiments, the remote computing device 1840 may include network-attached storage (e.g., as part of the storage device 1804). The remote computing device 1840 may store data generated by the chromatography system 1810, perform analyses of the data generated by the chromatography system 1810 (e.g., in accordance with programmed instructions), facilitate communication between the user local computing device 1820 and the chromatography system 1810, and/or facilitate communication between the service local computing device 1830 and the chromatography system 1810.

In some embodiments, one or more of the elements of the chromatography support system 1800 illustrated in FIG. 18 may not be present. Further, in some embodiments, multiple ones of various ones of the elements of the chromatography support system 1800 of FIG. 18 may be present. For example, a chromatography support system 1800 may include multiple user local computing devices 1820 (e.g., different user local computing devices 1820 associated with different users or in different locations). In another example, a chromatography support system 1800 may include multiple chromatography systems 1810, all in communication with service local computing device 1830 and/or a remote computing device 1840; in such an embodiment, the service local computing device 1830 may monitor these multiple chromatography systems 1810, and the service local computing device 1830 may cause updates or other information may be “broadcast” to multiple chromatography systems 1810 at the same time. Different ones of the chromatography systems 1810 in a chromatography support system 1800 may be located close to one another (e.g., in the same room) or farther from one another (e.g., on different floors of a building, in different buildings, in different cities, etc.). In some embodiments, a chromatography system 1810 may be connected to an Internet-of-Things (IoT) stack that allows for command and control of the chromatography system 1810 through a web-based application, a virtual or augmented reality application, a mobile application, and/or a desktop application. Any of these applications may be accessed by a user operating the user local computing device 1820 in communication with the chromatography system 1810 by the intervening remote computing device 1840. In some embodiments, a chromatography system 1810 may be sold by the manufacturer along with one or more associated user local computing devices 1820 as part of a local chromatography computing unit 1812.

In some embodiments, different ones of the chromatography systems 1810 included in a chromatography support system 1800 may be different types of chromatography systems 1810. In some such embodiments, the remote computing device 1840 and/or the user local computing device 1820 may combine data from different types of chromatography systems 1810 included in a chromatography support system 1800.

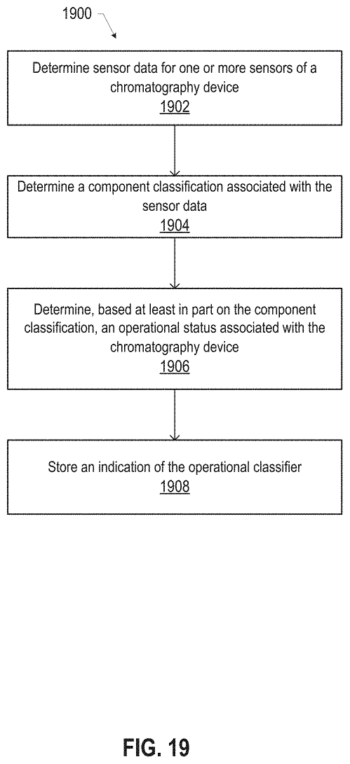

FIG. 19 shows an example method. The method 1900 may comprise a computer implemented method for providing a service for a chromatography device. A system and/or computing environment, such as the support module of FIG. 14, the GUI 1600 of FIG. 16, the computing device 1700 of FIG. 17, and/or chromatography support system 1800 may be configured to perform the method 1900. For example, any device separately or a combination of devices of the scientific instrument (e.g., the chromatography system) 1810, the user local computing device 1820, the service local computing device, and the remote computing device 1840 may perform the method 1900. Any of the features of the methods of FIGS. 12-13, 15 and 20-21 may be combined with any of the features and/or steps of the method 1900 of FIG. 19.

At step 1902 (e.g., first logic of the method 1900), sensor data for one or more sensors of a chromatography device may be determined (e.g., accessed, received, generated, detected). At least a portion of the sensor data may include (e.g., directly as a measurement and/or indirectly as a calculated value or processed data) a pressure profile representative of a pressure of the chromatography device. For example, the sensor data may comprise one or more of other pump pressure sensor data, compression data, power consumption data, detector output data, leak flow data, drive motor position data, or valve position data. In some embodiments, any one or more of these types of data (or other types of data) may be measured as an electrical current and/or voltage from one or more associated sensors. The sensor data may comprise directly measured data and/or values determined based on measured data. For example, compression data may comprise a firmware parameter derived from a motor position. The sensor data may be generated by a neural network or other model or calculation that gathers system information (e.g., directly from sensors) and/or provides parameter values for any later classification and/or failure detection process. The one or more sensors may comprise one or more of a pressure sensor, a motor position sensor, a vibration sensor (e.g., configured to detect a broken bearing), or a leak sensor. The chromatography device may comprise a high-performance liquid chromatography (HPLC) device. The sensor data may comprise data associated with a pump or other solvent delivery device. The pump may comprise one or more of a low-pressure gradient pump (e.g., 1000 bar), a high-pressure gradient pump with a camshaft, or a high-pressure gradient pump having a spindle.

At step 1904 (e.g., second logic of the method 1900), a component classification associated with the sensor data may be determined (e.g., generated, received, accessed, detected). The component classification may comprise a pulse classification which may also be referred to as a pressure classification. A pulse/pressure classification for an associated portion of a pressure profile (e.g., one or more pulsations) represented by the sensor data may be determined. The classification may be determined based on the sensor data and a computational model, which may include a machine-learning model and other rules or heuristics. The classification may be representative of a component state of the chromatography device. Example component states and/or classifications may comprise a normal state, a negative lag of compression control, a positive lag of compression control, an unusual state, a first piston leak, a second piston leak, a stroke previous air bubble, a first stroke of air bubble, a stroke (or number of strokes) after an air bubble, a spike (e.g., caused by particles plugging a component). The machine-learning model may comprise one or more of a random forest classifier model, a decision tree-based model, a linear classifier model, a k-nearest neighbor model, a support vector machine, a quadratic classifier, a genetic algorithm based model, a neural network, or a combination thereof.

Determining the component classification (e.g., pressure classification, pulse classification) may comprise inputting the sensor data or data based on the sensor data to the machine-learning model. The sensor data input into the machine-learning model may comprise a first portion of the sensor data. The first portion of the sensor data may comprise one or more of pressure data associated with the pump of the chromatography device, compression data, or drive motor position data.

The machine-learning model may classify pulsations, or other portions of a pressure profile, according to one or more of a plurality of states associated with the chromatography device. Other signal patterns that may be classified may be patterns associated a chromatography injection (e.g., the analysis process of one sample), sequences (e.g., multiple injections, the entire quantification process of a sample), sensor data associated with arbitrary time intervals, system processes that are not part of chromatographic analysis (e.g., an internal testing process), or a combination thereof. The states may comprise a plurality of normal states and a plurality of abnormal states. The states may indicate one or more of a type of failure or a component of the chromatography device associated with the failure. The states may comprise one or more of a positive lag, a negative lag, a normal stroke, or an unusual stroke. The states may comprise one or more of leakage in a first piston, leakage in a second piston, a pressure spike, an indication of an air bubble, or a combination thereof.

A pressure profile, representative of a pressure in a chromatography device, may be generated. A pressure profile may include one or more pulsations or other portions of a pressure profile corresponding to strokes of the pump of the chromatography device. A pulsation (or other portion of a pressure profile) may comprise a difference between a specified pressure value (e.g., an expected pressure value) and the actual pressure value. In some embodiments, pulsation data may be generated based on the pressure profile. For example, the pressure profile may be translated into pulsation data based on any appropriate mathematical process, such as those disclosed herein. In some embodiments, determining the pulse classification may be based on the pulsation data. For example, determining the pulse classification may comprise inputting the pulsation data into the machine-learning model. In some embodiments, one or more features for each of the plurality of pulsations in a pressure profile may be determined. The machine-learning model may be trained to classify each pulsation based on its corresponding one or more features. In some embodiments, inputting the sensor data to the machine-learning model may comprise inputting to the machine-learning model one or more features for each of one or more pulsations of a pressure profile.

At step 1906 (e.g., third logic of the method 1900), an operational status associated with the chromatography device may be determined. The operational status associated with the chromatography device may be determined based on at least a portion of the pulse classifications. The operational status may be representative of performance of the chromatography device. Example operational statuses may comprise a normal status, abnormal status, success status, a failure status, an inlet check valve failure (or inlet check valve success), an outlet check valve failure (or outlet check valve success), an air bubble (or no air bubble), an empty bottle (or a bottle not being empty), a leaky seal on a first piston (or a functional seal on a first piston), a leaky seal on a second piston (or a functional seal on a second piston), a plugging failure (or no plugging present), a leak at a mechanical connection (or all mechanical connections functional), or any combination thereof. Determining the operational status may comprise determining the operational status based on applying one or more classification rules to at least a portion of the pulse classifications. The one or more classification rules may comprise weighting rules for adjusting contributions of one or more of the classified pulsations or other signal pattern. The one or more classification rules may comprise filtering rules for filtering contributions of one or more of the classified pulsations or other signal pattern. The one or more classification rules may comprise logic rules that associate component classifications and potentially other sensor data (e.g., a second portion of the sensor data) with corresponding operational statuses. Determining the operational status may comprise determining the operational status based on analyzing the component classification (e.g., pressure classification, pulse classification) using a second portion of the sensor data different from a first portion input into the machine-learning model.

At step 1908 (e.g., fourth logic of the method 1900), an indication of the operational status may be stored. Storing the indication may comprise storing the indication by the chromatography device or in another computer device local or remote to a premises where the chromatography device is located. The indication may cause one or more of sending a message (e.g., sending an indication), outputting an alert on a display, or a service to be requested. A message may be sent. The message may be indicative of the operational status. Sending the message may comprise sending the message based on one or more of the operational status or storing the indication. Sending the message may comprise sending the message to trigger an action. The action may comprise one or more of causing a part to be ordered (e.g., by communicating with an ordering service), changing a parameter of the chromatography device, scheduling a maintenance operation (e.g., such that the chromatography device automatically performs the operation at the scheduled time, or such that maintenance interface is caused to provide a notification of a scheduled maintenance), causing the chromatography device to perform a recovery action, or causing the chromatography device to perform a diagnostic test.

Sending the message (e.g., sending an indication) may comprise causing output of the message via one or more of a display of the chromatography device or a display of a device in communication with the chromatography device. Sending the message may comprise sending, via a network, the message to a server (e.g., associated with a cloud based computing portal). Sending the message may comprise outputting the message via one or more of a user interface for operating the chromatography device or a diagnostic interface for analyzing functionality of the chromatography device. One or more steps of the method may be performed by one or more of the chromatography device, a computing device located at a premises where the chromatography device is located, or a computing device located external to the premises.

User feedback may be received based on the message. The message may be presented to the user. The message may comprise the classification, an indication of failure, and/or a maintenance schedule or maintenance operation for the chromatography device. The user may indicate whether the user agrees with the information in the message (e.g., classification, indication of failure, maintenance schedule, maintenance recommendation) or not. The indication of the user may be used to further train the machine-learning model. The indication of the user may be used to adjust a parameter of the system, such as a classification sensitivity of the machine-learning model. The user may provide and/or select reference measurements.

In some embodiments, information from multiple sensors (e.g., of different components, instruments) may be used together. An operational status and/or classification may be determined based on the information from multiple sensors. For example, a variation in behavior that occurs in multiple different sensors may be less or more likely to indicate a failure status. A variation from one component may be associated with a negative operational status, while a variation from multiple components may be associated with a positive operational status. Similarly, a variation from one component may be associated with a positive operational status, while a variation from multiple components may be associated with a negative operational status. The machine-learning model may be trained based data from a single component and/or multiple components. Rules applied to the result of one or multiple machine-learning models (e.g., a different model for each component) may be selected to reflect the use of one or multiple components. In some scenarios, sensor data from one component, or the result of putting that sensor data in a machine-learning model, may be used to validate and/or invalidate results from another machine-learning model and/or rule for determining operational status.

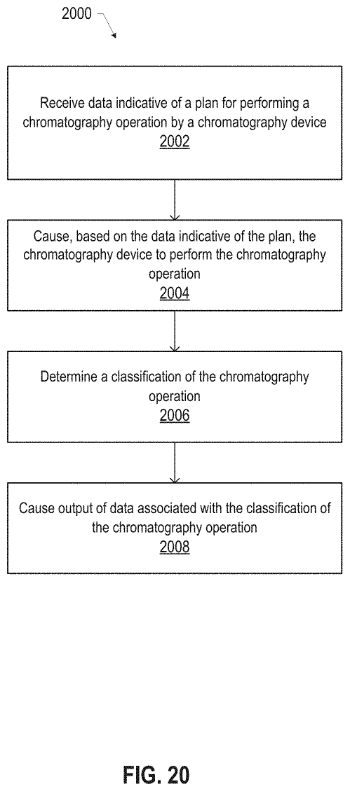

FIG. 20 shows an example method. The method 2000 may comprise a computer implemented method for providing a service for a chromatography device. A system and/or computing environment, such as the support module of FIG. 14, the GUI 1600 of FIG. 16, the computing device 1700 of FIG. 17, and/or chromatography support system 1800 may be configured to perform the method 2000. For example, any device separately or a combination of devices of the scientific instrument (e.g., the chromatography system) 1810, the user local computing device 1820, the service local computing device, and the remote computing device 1840 may perform the method 1900. Any of the features of the methods of FIGS. 12-13, 15, 19, and 21 may be combined with any of the features and/or steps of the method 2000 of FIG. 20.

At step 2002 (e.g., first logic of the method 2000), data indicative of a plan for performing a chromatography operation by a chromatography device may be received. The data indicative of the plan may be received based on user input via a user interface. The chromatography device may comprise a high-performance liquid chromatography (HPLC) device. The chromatography operation may comprise one or more of a chromatography injection operation, analysis of a material, or a combination thereof. The user interface may comprise a user interface for operating the chromatography device and/or a diagnostic interface for analyzing functionality of the chromatography device.

At step 2004 (e.g., second logic of the method 2000), the chromatography device may be caused to perform the chromatography operation. The chromatography device may be caused based on the data indicative of the plan. Causing the chromatography device to perform the chromatography operation may be in response to the user input. The data indicative of the plan may comprise a time to perform the chromatography operation, and the chromatography device may be caused to perform the chromatography operation at the scheduled time. Submission of the data indicative of the plan may automatically trigger causing performance of the chromatography operation.

At step 2006 (e.g., third logic of the method 2000), a classification of the chromatography operation may be determined (e.g., generated, received, accessed, detected). The classification of the chromatography operation may be determined based on inputting sensor data to a computational model that may include a machine-learning model and/or other rules or heuristics. The sensor data may be representative of (e.g., directly as a measurement and/or indirectly as a calculated value or processed data) performance of the chromatography device during the chromatography operation. The sensor data may be collected during the chromatography operation. The sensor data may comprise directly measured data and/or values determined based on measured data. For example, compression data may comprise a firmware parameter derived from a motor position. The sensor data may be generated by a neural network or other model or calculation that gathers system information (e.g., including sensor data) and/or provides parameter values for any later classification and/or failure detection process.

The machine-learning model may comprise one or more of a random forest classifier model, a decision tree-based model, a linear classifier model, a k-nearest neighbor model, a support vector machine, a quadratic classifier, a genetic algorithm based model, a neural network, or a combination thereof. The sensor data may comprise one or more of other pump pressure sensor data, compression data, power consumption data, detector output data, leak flow data, drive motor position data, or valve position data. The sensor data may comprise data from one or more of a pressure sensor, a motor position sensor, or leak sensor. The sensor data may comprise pressure data associated with a pump or other solvent delivery device of the chromatography device. The pump may comprise one or more of a low-pressure gradient pump (e.g., 1000 bar), a high-pressure gradient pump with a camshaft, or a high-pressure gradient pump having a spindle.

The machine-learning model may be trained to classify sensor data according to one or more of a plurality of different states associated with the chromatography device. The states may comprise a plurality of normal states and a plurality of abnormal states. The states may indicate one or more of a type of failure or a component of the chromatography device associated with the failure. The states may comprise one or more of a positive lag, a negative lag, a normal stroke, or an unusual stroke. The states may comprise one or more of leakage in a first piston, leakage in a second piston, a pressure spike, or an indication of an air bubble.

The classification may be representative of one or more of a success, a failure, or other component state of the chromatography device. For example, the classification may represent an operational status of a component of the chromatography device. Example component states and/or classifications may comprise a normal state, a negative lag of compression control, a positive lag of compression control, an unusual state, a first piston leak, a second piston leak, a stroke previous air bubble, a first stroke of air bubble, a stroke (or number of strokes) after an air bubble, a spike (e.g., caused by particles plugging a component), or a combination thereof. Example classification may comprise a normal status of a component, abnormal status of a component, success status of a component, a failure status of a component, an inlet check valve failure (or inlet check valve success), an outlet check valve failure (or outlet check valve success), an air bubble (or no air bubble), an empty bottle (or a bottle not being empty), a leaky seal on a first piston (or a functional seal on a first piston), a leaky seal on a second piston (or a functional seal on a second piston), a plugging failure (or no plugging present), a leak at a mechanical connection (or all mechanical connections functional), or any combination thereof.

Determining the classification may comprise determining a classification (e.g., pulse classification, or other signal pattern, variation classification, pressure classification) for at least a portion of a pressure profile. In some embodiments, the portion of a pressure profile may include one or more pressure pulsations, with individual pulsations corresponding to strokes of the pump of the chromatography device. Pulsations may be identified based on the pressure profile, and in some embodiments, determining the classification may be based on the identified pulsations. For example, determining the classification may comprise inputting data representative of the pulsations into the machine-learning model. In some particular embodiments, one or more features of at least a portion of the pressure profile (e.g., one or more pulsations) may be determined, and a machine-learning model may be trained to classify individual pulsations or other portions of a pressure profile based on the corresponding features. For example, inputting the sensor data to the machine-learning model may comprise inputting one or more features for each of the pulsations or other portions of a pressure profile. Determining the classification may comprise determining the classification based on applying one or more classification rules to at least a portion of the classifications. The one or more classification rules may comprise weighting rules for adjusting contributions of one or more of the classified variations (e.g., pulsations, or other signal patterns). The one or more classification rules may comprise filtering rules for filtering contributions of one or more of the classified variations (e.g., pulsations, or other signal patterns). The one or more classification rules may comprise logic rules that associate classifications and sensor data with corresponding operational statuses.

At step 2008 (e.g., fourth logic of the method 2000), output of data associated with the classification of the chromatography operation may be caused. The output of data associated with the classification of the chromatography operation may be caused via the user interface. The data associated with the classification may comprise one or more of an indication that the operation is invalid, a warning regarding accuracy of the operation, or a recommendation to repeat the chromatography operation. The data associated with the classification may comprise one or more of a recommendation to schedule maintenance, an indication of a faulty component of the chromatography device, or a recommendation to change an operational parameter related to the chromatography operation.

Causing output of the data may comprise sending a message. Sending the message may comprise sending the message to trigger an action. The action may comprise one or more of causing a part to be ordered, changing a parameter of the chromatography device, scheduling a maintenance operation, causing the chromatography device to perform a recovery action, or causing the chromatography device to perform a diagnostic test. Sending the message may comprise sending, via a network, the message to a server. An indication of the classification may be stored in one or more of the chromatography device, a storage device, a device located at a premises where the chromatography device is located, or a device located external to the premises. One or more steps of the method may be performed by one or more of the chromatography device, a computing device located at a premises where the chromatography device is located, or a computing device located external to the premises.

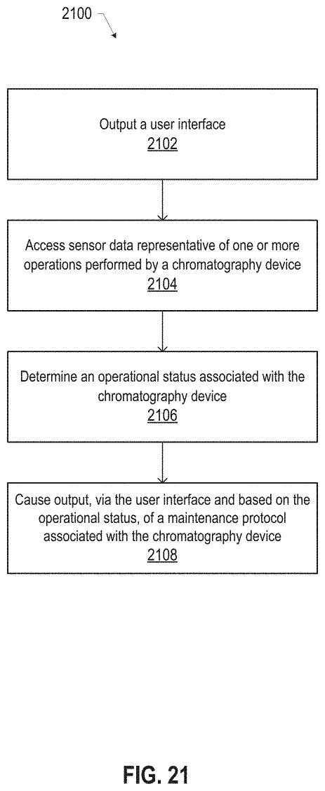

FIG. 21 shows an example method. The method 2100 may comprise a computer implemented method for providing a service for a chromatography device. A system and/or computing environment, such as the support module of FIG. 14, the GUI 1600 of FIG. 16, the computing device 1700 of FIG. 17, and/or chromatography support system 1800 may be configured to perform the method 2100. For example, any device separately or combination of devices of the scientific instrument (e.g., the chromatography system) 1810, the user local computing device 1820, the service local computing device, and the remote computing device 1840 may perform the method 2100. Any of the features of the methods of FIGS. 12-13, 15, 19, and 20 may be combined with any of the features and/or steps of the method 2100 of FIG. 21.

At step 2102 (e.g., first logic of the method 2100), a user interface may be output. The user interface may be configured to provide diagnostic information for a chromatography device may be output. The chromatography device may comprise a high-performance liquid chromatography (HPLC) device.

At step 2104 (e.g., second logic of the method 2100), sensor data representative of (e.g., directly as a measurement and/or indirectly as calculated value or processed data) one or more operations performed by the chromatography device may be accessed. The sensor data may comprise one or more of other pump pressure sensor data, compression data, power consumption data, detector output data, leak flow data, drive motor position data, or valve position data. The sensor data may comprise data from one or more of a pressure sensor, a motor position sensor, or leak sensor. The sensor data may comprise directly measured data and/or values determined based on measured data. For example, compression data may comprise a firmware parameter derived from a motor position. The sensor data may be generated by a neural network or other model or calculation that gathers some kind of system information (e.g., including sensor data) and/or provides parameter values for any later classification and/or failure detection process.

The sensor data may comprise pressure data associated with a pump or other solvent delivery device of the chromatography device. The pump may comprise one or more of a low-pressure gradient pump (e.g., 1000 bar), a high-pressure gradient pump with a camshaft, or a high-pressure gradient pump having a spindle. The one or more operations may comprise one or more of a diagnostic operation, an operation while in standby mode, an operation to analyze a material, or a chromatography injection operation. The one or more operations may comprise one or more of a chromatography injection operation or analysis of a material.

At step 2106 (e.g., third logic of the method 2100), an operational status (e.g., operational status of one or more components) associated with the chromatography device may be determined (e.g., generated, accessed, received, detected). The operational status may be representative of one or more of a success, a failure, or another performance characteristic associated with operation of the chromatography device. The operational status may be based on a component state of the chromatography device and/or may include a component state of the chromatography device. Example component states and/or classifications may comprise a normal state of a component, a negative lag of compression control, a positive lag of compression control, an unusual state of a component, a first piston leak, a second piston leak, a stroke previous air bubble, a first stroke of air bubble, a stroke (or number of strokes) after an air bubble, a spike (e.g., caused by particles plugging a component), or a combination thereof. An example operational status may comprise a normal status, abnormal status, success status, a failure status, an inlet check valve failure (or inlet check valve success), an outlet check valve failure (or outlet check valve success), an air bubble (or no air bubble), an empty bottle (or a bottle not being empty), a leaky seal on a first piston (or a functional seal on a first piston), a leaky seal on a second piston (or a functional seal on a second piston), a plugging failure (or no plugging present), a leak at a mechanical connection (or all mechanical connections functional), or any combination thereof.

The operational status of the chromatography device may be determined based on inputting the sensor data to a computational model, which may include a machine-learning model in combination with other rules or heuristics, if-then statements, logical model). The machine-learning model may be trained to classify the sensor data according to one or more of a plurality of states of one or more components of the chromatography device. The machine-learning model may comprise a random forest classifier model or another suitable machine-learning model. The states may comprise a plurality of normal states and a plurality of abnormal states. The states may comprise indicate one or more of a type of failure or a component of the chromatography device associated with the failure. The states may comprise one or more of positive lag, a negative lag, a normal stroke, or an unusual stroke. The states may comprise one or more of leakage in a first piston, leakage in a second piston, a pressure spike, or an indication of an air bubble.

Determining the operational status may comprise determining a classification of the sensor data using the machine-learning model. As noted above, determining the classification may comprise determining a classification (e.g., pulse classification, or other signal pattern) for at least a portion of a pressure profile (e.g., including one or more pressure pulsations corresponding to strokes of a pump of the chromatography device) included in the sensor data. One or more features for different portions of the pressure profile (e.g., different pulsations) may be determined. The machine-learning model may be trained to classify each pressure profile portion based on the corresponding features. For example, inputting the sensor data to the machine-learning model may comprise inputting the one or more features for each of one or more pressure profile portions (e.g., one or more pulsations).

Determining the operational status may comprise determining the operational status based on applying one or more classification rules to the classification. Determining the operational status may comprise determining the operational status based on applying one or more classification rules to at least a portion of the classifications (e.g., pulse classifications). The one or more classification rules may comprise weighting rules for adjusting contributions of one or more of the classified variations (e.g., pressure classification, pulsation, or other classification). The one or more classification rules may comprise filtering rules for filtering contributions of one or more of the classified pressure profile portions. The one or more classification rules may comprise logic rules that associate classifications (e.g., pulsation classifications or classifications of other portions of a pressure profile) and sensor data with corresponding operational statuses.

At step 2108 (e.g., fourth logic of the method 2100), output of a maintenance protocol associated with the chromatography device may be caused. The output of the maintenance protocol associated with the chromatography device may be caused via the user interface. The output of the maintenance protocol associated with the chromatography device may be caused based on the operational status. The maintenance protocol may comprise an indication of one or more components of the chromatography device to replace and/or timing information for replacing the one or more components. The maintenance protocol may comprise an indication of one or more the plurality of states. Causing output of the maintenance protocol may comprise causing an action to performed associated with maintenance of the chromatography device. The action may comprise one or more of causing a part to be ordered, changing a parameter of the chromatography device, scheduling a maintenance operation, causing the chromatography device to perform a recovery action, or causing the chromatography device to perform a diagnostic test.

The following paragraphs provide various examples of the embodiments disclosed herein. Any of the features of the example embodiments may be combined with any of the features of the other example embodiments.

Example 1 is a method comprising: determining sensor data for one or more sensors of a chromatography device, wherein at least a portion (e.g., profile data, including a pressure profile representative of pump pressure and/or a flow profile representative of flow variations) of the sensor data is representative of a plurality of pressure variations; determining (e.g., generating, accessing, receiving), based on the sensor data and/or a computational model, a classification (e.g., a component classification, pulse classification, pressure classification, variation classification, profile classification, flow classification) for an associated one or more pressure variations (e.g., pulsations) represented by the sensor data, wherein the pressure classification is representative of a component state of the chromatography device (e.g., and wherein the machine-learning model classifies pressure variations according to one or more of a plurality of states associated with the chromatography device); determining (e.g., generating, accessing, receiving), based at least in part on at least a portion of the pressure variations (e.g., pressure classifications), an operational status associated with the chromatography device (e.g., and wherein the operational status is representative of one or more of success characteristics or failure characteristics of operation of the chromatography device); and (optionally) storing an indication of the operational status.

Example 2 includes the subject matter of Example 1, and further specifies that a first portion (e.g., the profile data) of the sensor data comprises one or more of pressure data associated with a pump of the chromatography device, compression data, or drive motor position data.

Example 3 includes the subject matter of any one of Examples 1-2, and further specifies that the sensor data comprises one or more of compression data, leak flow data, electrical current data, drive motor position data, or valve position data.

Example 4 includes the subject matter of any one of Examples 1-3, and further specifies that the one or more sensors comprises one or more of a pressure sensor, a motor position sensor, a vibration sensor, or a leak sensor.

Example 5 includes the subject matter of any one of Examples 1-4, and further specifies that the chromatography device comprises a high-performance liquid chromatography (HPLC) device.

Example 6 includes the subject matter of any one of Examples 1-5, and further specifies that the machine-learning model comprises one or more of a random forest classifier model, a decision tree based model, a linear classifier model, a k-nearest neighbor model, a support vector machine, a quadratic classifier, a genetic algorithm based model, a neural network, or a combination thereof.

Example 7 includes the subject matter of any one of Examples 1-6, and further includes generating pulsation data (e.g., or variation data) indicative of a plurality of pressure variations (e.g., or pulsations), at least a portion of the pressure variations corresponding to strokes of a pump of the chromatography device.

Example 8 includes the subject matter of Example 7, and further specifies that determining the classification (e.g., pressure classification, pulse classification) is based on the pulsation data.

Example 9 includes the subject matter of any one of Examples 7-8, and further specifies that determining the classification (e.g., pulse classification) comprises inputting the pulsation data into the machine-learning model.

Example 10 includes the subject matter of any one of Examples 7-9, and further includes determining a plurality of features for each of the plurality of pulsations (e.g., or pressure variations), wherein the machine-learning model is trained to classify each pulsation (e.g., or variation) based on the corresponding plurality of features.

Example 11 includes the subject matter of any one of Examples 1-10, and further specifies that determining the operational status comprises determining the operational status based on applying one or more classification rules to at least a portion of the classifications (e.g., pressure classifications, pulse classifications).

Example 12 includes the subject matter of Example 11, and further specifies that the one or more classification rules comprises weighting rules for adjusting contributions of one or more of the classified pressure variations (e.g., pulsations).

Example 13 includes the subject matter of any one of Examples 11-12, and further specifies that the one or more classification rules comprises filtering rules for filtering contributions of one or more of the classified pressure variations (e.g., pulsations).

Example 14 includes the subject matter of any one of Examples 11-13, and further specifies that the one or more classification rules comprises logic rules that associate classifications (e.g., pressure classifications, pulse classifications) and sensor data with corresponding operational statuses.

Example 15 includes the subject matter of any one of Examples 11-14, and further specifies that determining the operational status comprises determining the operational status based on analyzing the classification (e.g., pressure classification, pulse classification) using a second portion of the sensor data different from a first portion input into the machine-learning model.

Example 16 includes the subject matter of any one of Examples 1-15, and further includes storing the indication causes one or more of sending a message, outputting an alert on a display, or a service to be requested.

Example 17 includes the subject matter of any one of Examples 1-16, and further includes sending a message.

Example 18 includes the subject matter of Example 17, and further specifies that sending the message comprises sending the message based on one or more of the operational status or storing the indication.

Example 19 includes the subject matter of any one of Examples 17-18, and further specifies that sending the message comprises sending the message to trigger an action, wherein the action comprises one or more of causing a part to be ordered, changing a parameter of the chromatography device, scheduling a maintenance operation, causing the chromatography device to perform a recovery action, or causing the chromatography device to perform a diagnostic test.

Example 20 includes the subject matter of any one of Examples 17-19, and further specifies that sending the message comprises causing output of the message via one or more of a display of the chromatography device or a display of a device in communication with the chromatography device.

Example 21 includes the subject matter of any one of Examples 17-20, and further specifies that sending the message comprises sending, via a network, the message to a server.

Example 22 includes the subject matter of any one of Examples 1-21, and further specifies that one or more steps of the method are performed by one or more of the chromatography device, a computing device located at a premises where the chromatography device is located, or a computing device located external to the premises.

Example 23 is a method comprising: receiving, based on user input via a user interface, data indicative of a plan for performing a chromatography operation by a chromatography device; causing, based on the data indicative of the plan, the chromatography device to perform the chromatography operation; determining (e.g., generating, accessing, receiving), based on inputting to a machine-learning model (e.g., or other model, rules, heuristics, if-then statements, logical model) sensor data (e.g., or data determined based on the sensor data) representative of performance of the chromatography device during the chromatography operation, a classification of the chromatography operation, wherein the classification is representative of one or more of a success, a failure, or a component state associated with operation of the chromatography device, (e.g., and wherein the machine-learning model is trained to classify sensor data according to one or more of a plurality of different states associated with the chromatography device); and causing output, via the user interface, of data associated with the classification of the chromatography operation.

Example 24 includes the subject matter of Example 23, and further specifies that the chromatography device comprises a high-performance liquid chromatography (HPLC) device.

Example 25 includes the subject matter of any one of Examples 23-24, and further specifies that the chromatography operation comprises one or more of a chromatography injection operation or analysis of a material.

Example 26 includes the subject matter of any one of Examples 23-25, and further specifies that the user interface comprises a user interface for operating the chromatography device or a diagnostic interface for analyzing functionality of the chromatography device.

Example 27 includes the subject matter of any one of Examples 23-26, and further includes causing the chromatography device to perform the chromatography operation is in response to the user input.

Example 28 includes the subject matter of any one of Examples 23-27, and further specifies that the machine-learning model comprises one or more of a random forest classifier model, a decision tree based model, a linear classifier model, a k-nearest neighbor model, a support vector machine, a quadratic classifier, a genetic algorithm based model, a neural network, or a combination thereof.

Example 29 includes the subject matter of any one of Examples 23-28, and further specifies that the sensor data comprises one or more of compression data, leak flow data, electrical current data, drive motor position data, or valve position data.

Example 30 includes the subject matter of any one of Examples 23-29, and further specifies that the sensor data comprises data from one or more of a pressure sensor, a motor position sensor, or leak sensor.

Example 31 includes the subject matter of any one of Examples 23-30, and further specifies that the sensor data comprises pressure data associated with a pump of the chromatography device.

Example 32 includes the subject matter of any one of Examples 23-31, and further specifies that determining the classification comprises determining a pulse classification (e.g., or pressure classification, variation classification, classification) for at least a portion of a plurality of pulsations (e.g., or a plurality of pressure variations) associated with the sensor data.

Example 33 includes the subject matter of Example 32, and further includes generating (e.g., based on the sensor data) pulsation data indicative of the plurality of pulsations, at least a portion of the pulsations corresponding to strokes of a pump of the chromatography device.

Example 34 includes the subject matter of Example 33, and further specifies that determining the pulse classification is based on the pulsation data.

Example 35 includes the subject matter of any one of Examples 23-34, and further specifies that determining the pulse classification comprises inputting the pulsation data into the machine-learning model.

Example 36 includes the subject matter of any one of Examples 32-35, and further includes determining a plurality of features for each of the plurality of pulsations, wherein the machine-learning model is trained to classify each pulsation based on the corresponding plurality of features.

Example 37 includes the subject matter of any one of Examples 32-36, and further specifies that determining the classification comprises determining the classification based on applying one or more classification rules to at least a portion of the pulse classifications.

Example 38 includes the subject matter of Example 37, and further specifies that the one or more classification rules comprises weighting rules for adjusting contributions of one or more of the classified pulsations.

Example 39 includes the subject matter of any one of Examples 37-38, and further specifies that the one or more classification rules comprises filtering rules for filtering contributions of one or more of the classified pulsations.

Example 40 includes the subject matter of any one of Examples 37-39, and further specifies that the one or more classification rules comprises logic rules that associate pulse classifications (e.g., or pressure classifications, variation classifications) and sensor data with corresponding operational statuses.

Example 41 includes the subject matter of any one of Examples 23-40, and further specifies that the data associated with the classification comprises one or more of an indication that the operation is invalid, a warning regarding accuracy of the operation, or a recommendation to repeat the chromatography operation.

Example 42 includes the subject matter of any one of Examples 23-41, and further specifies that the data associated with the classification comprises one or more of a recommendation to schedule maintenance, an indication of a faulty component of the chromatography device, or a recommendation to change an operational parameter related to the chromatography operation.

Example 43 includes the subject matter of any one of Examples 23-42, and further specifies that causing output of the data comprises sending a message.

Example 44 includes the subject matter of Example 43, and further specifies that sending the message comprises sending the message to trigger an action, wherein the action comprises one or more of causing a part to be ordered, changing a parameter of the chromatography device, scheduling a maintenance operation, causing the chromatography device to perform a recovery action, or causing the chromatography device to perform a diagnostic test.

Example 45 includes the subject matter of any one of Examples 43-44, and further specifies that sending the message comprises sending, via a network, the message to a server.

Example 46 includes the subject matter of any one of Examples 23-45, and further includes storing an indication of the classification in one or more of the chromatography device, a storage device, a device located at a premises where the chromatography device is located, or a device located external to the premises.

Example 47 includes the subject matter of any one of Examples 23-46, and further specifies that one or more steps of the method are performed by one or more of the chromatography device, a computing device located at a premises where the chromatography device is located, or a computing device located external to the premises.

Example 48 is a method comprising: outputting a user interface configured to provide diagnostic information for a chromatography device; accessing sensor data representative of one or more operations performed by the chromatography device; determining (e.g., generating, accessing, receiving), based on sensor data (e.g., or data determined based on the sensor data) and a machine-learning model (e.g., or other model, rules, heuristics, if-then statements, logical model), an operational status associated with the chromatography device, wherein the operational status is representative of one or more of a success, a failure, or a component state associated with operation of the chromatography device (e.g., and wherein the machine-learning model is trained to classify the sensor data according to one or more of a plurality of states of the chromatography device); and causing output, via the user interface and based on the operational status, of a maintenance protocol associated with the chromatography device.

Example 49 includes the subject matter of Example 48, and further specifies that the chromatography device comprises a high-performance liquid chromatography (HPLC) device.

Example 50 includes the subject matter of any one of Examples 48-49, and further specifies that the one or more operations performed by the chromatography device comprise one or more of a chromatography injection operation or analysis of a material.

Example 51 includes the subject matter of any one of Examples 48-50, and further specifies that the sensor data comprises one or more of compression data, leak flow data, electrical current data, drive motor position data, or valve position data.

Example 52 includes the subject matter of any one of Examples 48-51, and further specifies that the sensor data comprises data from one or more of a pressure sensor, a motor position sensor, or leak sensor.

Example 53 includes the subject matter of any one of Examples 48-52, and further specifies that the sensor data comprises pressure data associated with a pump of the chromatography device.

Example 54 includes the subject matter of any one of Examples 48-53, and further specifies that the one or more operations comprises one or more of a diagnostic operation, an operation while in standby mode, an operation to analyze a material, or a chromatography injection operation.

Example 55 includes the subject matter of Example any one of claims 48-54, and further specifies that the machine-learning model comprises one or more of a random forest classifier model, a decision tree based model, a linear classifier model, a k-nearest neighbor model, a support vector machine, a quadratic classifier, a genetic algorithm based model, a neural network, or a combination thereof.

Example 56 includes the subject matter of any one of Examples 48-55, and further specifies that determining the operational status comprises determining (e.g., generating, receiving, accessing) a classification of the sensor data using the machine-learning model.

Example 57 includes the subject matter of Example 56, and further specifies that determining the classification comprises determining (e.g., generating, receiving, accessing) a pulse classification (e.g., or pressure classification, variation classification) for at least a portion of a plurality of pulsations (e.g., or a plurality of pressure variations) associated with the sensor data.

Example 58 includes the subject matter of Example 57, and further includes generating (e.g., based on the sensor data) pulsation data indicative of the plurality of pulsations, at least a portion of the pulsations (e.g., pressure variations) corresponding to strokes of a pump of the chromatography device.

Example 59 includes the subject matter of any one of Examples 57-58, and further specifies that determining the pulse classification is based on the pulsation data.

Example 60 includes the subject matter of any one of Examples 57-59, and further specifies that determining the pulse classification comprises inputting the pulsation data into the machine-learning model.

Example 61 includes the subject matter of any one of Examples 57-60, and further includes determining a plurality of features for each of the plurality of pulsations, wherein the machine-learning model is trained to classify each pulsation based on the corresponding plurality of features.

Example 62 includes the subject matter of any one of Examples 48-61, and further specifies that determining the operational status comprises determining the operational status based on applying one or more classification rules to the classification.

Example 63 includes the subject matter of any one of Examples 48-62, and further specifies that determining the operational status comprises determining the operational status based on applying one or more classification rules to one or more pulse classifications.

Example 64 includes the subject matter of Example 63, and further specifies that the one or more classification rules comprises weighting rules for adjusting contributions of one or more of the classified pulsations.

Example 65 includes the subject matter of any one of Examples 63-64, and further specifies that the one or more classification rules comprises filtering rules for filtering contributions of one or more of the classified pulsations.

Example 66 includes the subject matter of any one of Examples 63-65, and further specifies that the one or more classification rules comprises logic rules that associate pulse classifications and sensor data with corresponding operational classifications.

Example 67 includes the subject matter of any one of Examples 48-66, and further specifies that the maintenance protocol comprises an indication of one or more components of the chromatography device to replace and timing information for replacing the one or more components.

Example 68 includes the subject matter of any one of Examples 48-67, and further specifies that causing output of the maintenance protocol comprises causing an action to performed associated with maintenance of the chromatography device, wherein the action comprises one or more of causing a part to be ordered, changing a parameter of the chromatography device, scheduling a maintenance operation, causing the chromatography device to perform a recovery action, or causing the chromatography device to perform a diagnostic test.

Example 69 is a method comprising: determining sensor data for one or more sensors of a chromatography device, wherein the sensor data includes a profile data representative of pump activity in the chromatography device, wherein the profile data includes one or more of a flow profile or a pressure profile; generating, based on the sensor data, a component classification for the profile data, wherein the component classification is representative of a component state of the chromatography device; and generating, based on the component classification, an operational status associated with the chromatography device, wherein the operational status is representative of performance of the chromatography device.

Example 70 includes the subject matter of Example 69, and further specifies that the chromatography device comprises a high-performance liquid chromatography (HPLC) device, and wherein the sensor data includes data representative of one or more of other pump pressure sensor data, compression data, power consumption data, or detector output data.

Example 71 includes the subject matter of any one of Examples 69-70, and further includes generating the component classification is based on an output of a machine-learning model; and further specifies that an input to the machine-learning model is data representative of the pressure profile.

Example 72 includes the subject matter of Example 71, and further includes identifying an individual portion of the pressure profile as corresponding to an individual stroke of a pump of the chromatography device; and further specifies that the data representative of the pressure profile includes data representative of the identified individual portion of the pressure profile.

Example 73 includes the subject matter of any one of Examples 69-72, and further specifies that generating the operational status includes on applying one or more classification rules to the component classification.

Example 74 includes the subject matter of any one of Examples 69-73, and further specifies that generating the operational status is based on sensor data other than the pressure profile.

Example 75 includes the subject matter of any one of Examples 69-74, and further includes performing an action based on the operational status, wherein the action includes sending a message, outputting an alert on a user interface device, requesting a service call, outputting an indication of one or more troubleshooting steps to be performed, repeating an injection, a self-recovery action, or writing a message to a log file.

Example 76 is a method comprising: receiving, based on a user input to a user interface of a chromatography system, data indicative of a procedure for performing a chromatography operation by a chromatography device of the chromatography system; causing, based on the data indicative of the procedure, the chromatography device to perform the chromatography operation; generating, based on sensor data representative of performance of the chromatography device during the chromatography operation, a classification of the chromatography operation, wherein the classification is representative of one or more of a component state associated with operation of the chromatography device; and performing an action based on the classification.

Example 77 includes the subject matter of Example 76, and further specifies that the sensor data includes data representative of one or more of pressure data, other pump pressure sensor data, compression data, power consumption data, or detector output data.

Example 78 includes the subject matter of any one of Examples 76-77, and further specifies that the chromatography operation comprises one or more of a chromatography injection operation or analysis of a material.

Example 79 includes the subject matter of any one of Examples 76-78, and further specifies that the action includes outputting an advisory message via the user interface, and wherein the advisory message includes an indication that the chromatography operation is invalid, a warning regarding accuracy of the chromatography operation, or a recommendation to repeat the chromatography operation.

Example 80 includes the subject matter of any one of Examples 76-79, and further specifies that the action includes outputting an advisory message via the user interface, and wherein the advisory message includes a recommendation to schedule maintenance, an indication of a faulty component of the chromatography device, or a recommendation to change an operational parameter related to the chromatography operation.

Example 81 includes the subject matter of any one of Examples 76-80, and further specifies that the action includes causing a part to be ordered, changing a parameter of the chromatography device, scheduling a maintenance operation, causing the chromatography device to perform a recovery action, or causing the chromatography device to perform a diagnostic test.

Example 82 is a method comprising: accessing sensor data representative of one or more operations performed by a chromatography device; generating, based on the sensor data, an operational status associated with the chromatography device, wherein the operational status is representative of performance of the chromatography device; and causing output, via a user interface and based on the operational status, of a maintenance protocol associated with the chromatography device.

Example 83 includes the subject matter of Example 82, and further specifies that the one or more operations performed by the chromatography device comprise one or more of a chromatography injection operation or analysis of a material.

Example 84 includes the subject matter of any one of Examples 82-83, and further specifies that the one or more operations comprises a diagnostic operation or an operation while in standby mode.

Example 85 includes the subject matter of any one of Examples 82-84, and further specifies that the sensor data includes data representative of a pump pressure of the chromatography device; and that generating the operational status is based on the data representative of the pump pressure.

Example 86 includes the subject matter of Example 85, and further includes identifying, in the data representative of the pump pressure, pulsations corresponding to strokes of a pump of the chromatography device; and further specifies that wherein the operational status is based on the identified pulsations.

Example 87 includes the subject matter of any one of Examples 82-86, and further specifies that the maintenance protocol comprises an indication of one or more components of the chromatography device to replace.

Example 88 includes the subject matter of Example 87, and further specifies that the maintenance protocol further includes timing information for replacing the one or more components.

Example 89 is a device comprising: one or more processors; and a memory storing instructions that, when executed by the one or more processors, cause the device to perform the methods of any one of Examples 1-88.

Example 90 is a non-transitory computer-readable medium storing instructions that, when executed by one or more processors, cause a device to perform the methods of any one of Examples 1-88.

Example 91 is a system comprising: a chromatography device configured to perform one or more chromatography operations; and a computing device comprising one or more processors, and a memory, wherein the memory stores instructions that, when executed by the one or more processors, cause the computing device to perform the methods of any one of Examples 1-88.

Example 92 is a scientific instrument support apparatus, comprising logic to perform the methods of any one of Examples 1-88.

Example 93 is a computing device, including logic configured to cause the performance of any of the embodiments disclosed herein.

Example 94 includes any of the chromatography support modules disclosed herein.

Example 95 includes any of the methods disclosed herein.

Example 96 includes any of the GUIs disclosed herein.

Example 97 includes any of the chromatography support computing devices and systems disclosed herein.

1. A method comprising:
determining sensor data for one or more sensors of a chromatography device, wherein the sensor data includes profile data representative of pump activity in the chromatography device, and wherein the profile data includes one or more of a flow profile or a pressure profile;
generating, based on the sensor data, a component classification for the profile data, wherein the component classification is representative of a component state of the chromatography device; and
generating, based on the component classification, an operational status associated with the chromatography device, wherein the operational status is representative of performance of the chromatography device.

2. The method of claim 1, wherein the chromatography device comprises a high-performance liquid chromatography (HPLC) device, and wherein the sensor data includes data representative of one or more of other pump pressure sensor data, compression data, power consumption data, or detector output data.

3. The method of claim 1, wherein:
generating the component classification is based on an output of a machine-learning model; and
an input to the machine-learning model is data representative of the profile data.

4. The method of claim 3, further comprising:
identifying an individual portion of the profile data as corresponding to an individual stroke of a pump of the chromatography device;
wherein the data representative of the profile data includes data representative of the identified individual portion of the profile data.

5. The method of claim 1, wherein generating the operational status includes on applying one or more classification rules to the component classification.

6. The method of claim 1, wherein generating the operational status is based on sensor data other than the profile data.

7. The method of claim 1, further comprising:
performing an action based on the operational status, wherein the action includes sending a message, outputting an alert on a user interface device, requesting a service call, outputting an indication of one or more troubleshooting steps to be performed, repeating an injection, a self-recovery action, or writing a message to a log file.

8. A method comprising:
receiving, based on a user input to a user interface of a chromatography system, data indicative of a procedure for performing a chromatography operation by a chromatography device of the chromatography system;
causing, based on the data indicative of the procedure, the chromatography device to perform the chromatography operation;
generating, based on sensor data representative of performance of the chromatography device during the chromatography operation, a classification of the chromatography operation, wherein the classification is representative of one or more of a component state associated with operation of the chromatography device; and
performing an action based on the classification.

9. The method of claim 8, wherein the sensor data includes data representative of one or more of pressure data, other pump pressure sensor data, compression data, power consumption data, or detector output data.

10. The method of claim 8, wherein the chromatography operation comprises one or more of a chromatography injection operation or analysis of a material.

11. The method of claim 8, wherein the action includes outputting an advisory message via the user interface, and wherein the advisory message includes an indication that the chromatography operation is invalid, a warning regarding accuracy of the chromatography operation, or a recommendation to repeat the chromatography operation.

12. The method of claim 8, wherein the action includes outputting an advisory message via the user interface, and wherein the advisory message includes a recommendation to schedule maintenance, an indication of a faulty component of the chromatography device, or a recommendation to change an operational parameter related to the chromatography operation.

13. The method of claim 8, wherein the action includes causing a part to be ordered, changing a parameter of the chromatography device, scheduling a maintenance operation, causing the chromatography device to perform a recovery action, or causing the chromatography device to perform a diagnostic test.

14. A method comprising:
accessing sensor data representative of one or more operations performed by a chromatography device;
generating, based on the sensor data, an operational status associated with the chromatography device, wherein the operational status is representative of performance of the chromatography device; and
causing output, via a user interface and based on the operational status, of a maintenance protocol associated with the chromatography device.

15. The method of claim 14, wherein the one or more operations performed by the chromatography device comprise one or more of a chromatography injection operation or analysis of a material.

16. The method of claim 14, wherein the one or more operations comprises a diagnostic operation or an operation while in standby mode.

17. The method of claim 14, wherein:
the sensor data includes data representative of a pump pressure of the chromatography device; and
generating the operational status is based on the data representative of the pump pressure.

18. The method of claim 17, further comprising:
identifying, in the data representative of the pump pressure, pulsations corresponding to strokes of a pump of the chromatography device;
wherein the operational status is based on the identified pulsations.

19. The method of claim 14, wherein the maintenance protocol comprises an indication of one or more components of the chromatography device to replace.

20. The method of claim 19, wherein the maintenance protocol further includes timing information for replacing the one or more components.
